(19) United States
(12) Patent Application Publication
(10) Pub. No.: US 2007/0282558 A1
(43) Pub. Date: Dec. 6, 2007

(54) Abnormal condition determining system for steering angle sensor

(75) Inventor: Yasuo Sagisaka, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/806,676

(22) Filed: Jun. 1, 2007

(30) Foreign Application Priority Data
Jun. 1, 2006 (JP) 2006-153143
Jun. 6, 2006 (JP) 2006-156772

(51) Int. Cl. G06F 19/00

(52) U.S. Cl. 702/116; 702/1; 702/127; 702/182; 702/187; 702/33; 702/34; 702/108; 702/183

(57) ABSTRACT

A purpose of the invention is to determine abnormal condition of a steering angle sensor at an early stage even in a vehicle, in which a yaw-rate sensor is not provided. An abnormal condition determining system of the invention has a first means for detecting whether the vehicle has passed through a curved road, based on geographical data and position data from a navigation system. The system further has a second means for determining an abnormal condition of the steering angle sensor, when an output change of the steering angle sensor does not reach a predetermined amount in spite that the first means detects that the vehicle has passed through the curved road.

### CROSS REFERENCE TO RELATED APPLICATION

This application is based on Japanese Patent Application Nos. 2006-153143, which is filed on Jun. 1, 2006, and 2006-156772, which is file on Jun. 6, 2006, the disclosures of which are incorporated herein by reference.

### FIELD OF THE INVENTION

The present invention relates to an abnormal condition determining system for a vehicle steering angle sensor, and more particularly, relates to an abnormal condition determining system for detecting an abnormal condition of the steering angle sensor as early as possible, when the abnormal condition, such as a disconnection or a short-circuit of a sensor wiring, has occurred.

### BACKGROUND OF THE INVENTION

A conventional system of this kind is known in the art, for example, as disclosed in Japanese Patent No. 3,161,303. According to the conventional system, the abnormal condition of the steering angle sensor is detected by use of a yaw-rate sensor mounted in a vehicle. For example, the conventional system determines the abnormal condition of the steering angle sensor, when a condition in which an output signal from the steering angle sensor is lower than a predetermined value continues for a period longer than a predetermined period, and when a number of switching over for a vehicle turning direction, which is detected by the yaw-rate sensor, exceeds a predetermined number.

According to the above conventional system, a vehicle behavior (a vehicle turning condition) is detected by the yaw-rate sensor, and the abnormal condition of the steering angle sensor is determined based on the detected vehicle behavior. Accordingly, a detecting accuracy for the abnormal condition of the steering angle sensor depends on a detecting accuracy of the yaw-rate sensor. The yaw-rate sensor is a sensor for detecting a speed (angular velocity) of a vehicle turning. Therefore, only a smaller output is obtained from the yaw-rate sensor in case of a low vehicle speed, compared with a case of a high vehicle speed, even when a steering angle is the same. Furthermore, even a very small angular velocity is not detected, as the case may be. In such a case, substantially no output is obtained from the sensor. As above, it is a problem that the conventional system may not determine a possible abnormal condition of the steering angle sensor, when the vehicle speed is low.

Furthermore, according to the above conventional system, the determination for the abnormal condition of the steering angle sensor can not be carried out, unless the yaw-rate sensor or any other sensors similar thereto is provided in a vehicle. However, the yaw-rate sensors are not yet in widespread use, and the yaw-rate sensors are not mounted in the standard-size cars. It is, therefore, difficult in the vehicles having no yaw-rate sensor to carry out diagnosis (determination) for the abnormal condition of the steering angle sensor with high precision.

### SUMMARY OF THE INVENTION

The present invention is made in view of the above problems. It is, therefore, an object of the present invention to provide an abnormal condition determining system for a vehicle steering angle sensor, according to which a possible abnormal condition of the steering angle sensor can be determined with high accuracy, even when the vehicle speed is low.

It is another object of the present invention to provide an abnormal condition determining system for a vehicle steering angle sensor, according to which a possible abnormal condition of the steering angle sensor can be determined with high accuracy without using the yaw-rate sensor.

According to a feature of the present invention, an abnormal condition determining system for a steering angle sensor (121) of a vehicle has a first means for detecting whether the vehicle has passed through a curved road, based on geographical data and position data from a navigation system. The system further has a second means for determining an abnormal condition of the steering angle sensor, when an output change of the steering angle sensor does not reach a predetermined amount in spite that the first means detects that the vehicle has passed through the curved road.

According to another feature of the present invention, an abnormal condition determining system for a steering angle sensor of a vehicle has a first means for detecting that a vehicle running track has plotted a curved line, based on position data from a navigation system. The system further has a second means for determining an abnormal condition of the steering angle sensor, when an output change of the steering angle sensor does not reach a predetermined amount in spite that the first means detects that the vehicle running track has plotted the curved line.

According to a further feature of the present invention, an abnormal condition determining system for a steering angle sensor of a vehicle has a first means for automatically setting a determination period during which it is determined whether an output of the steering angle sensor is in a normal condition or not, wherein a starting time point and an ending time point of the determination period are automatically set when at least one of conditions for an vehicle operation and a vehicle running condition satisfies a predetermined condition. The system further has a second means for determining an abnormal condition of the steering angle sensor, when an output change of the steering angle sensor during the above determination period does not reach a predetermined amount.

According to a still further feature of the present invention, an abnormal condition determining system for a steering angle sensor of a vehicle is applied to such a vehicle having an anti-lock braking system, according to which a vehicle wheel lock is prevented during a braking operation by controlling braking pressure based on information for rotational speed of respective vehicle wheels. The system has a first means for calculating a difference of wheel speeds between right and left vehicle wheels, based on the information for rotational speed of respective vehicle wheels. And the system further has a second means for determining an abnormal condition of the steering angle sensor, when an output change of the steering angle sensor does not reach a predetermined amount in spite that the difference of wheel speeds between right and left vehicle wheels calculated by the first means is larger than that of the vehicle running, on a straight road.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a vehicle control system having an engine ECU for performing a determination of an abnormal condition of a steering angle sensor, according to a first embodiment of the present invention;

FIG. 2 is a flowchart showing a process for determining the abnormal condition of the first embodiment;

FIG. 3 is a flowchart showing a process for determining a vehicle running on a curved road, which is one of the steps of FIG. 2;

FIG. 4 is a schematic view showing an example of a curvature radius;

FIGS. 5A to 5C are timing charts showing one example for determining the abnormal condition, according to the first embodiment;

FIG. 6 is a schematic view showing steered angles of a vehicle at respective timing points of FIGS. 5A to 5C;

FIG. 7 is a flowchart showing a process for determining the abnormal condition according to a second embodiment;

FIG. 8 is a flowchart showing a process for determining a vehicle entering to a curved road, which is one of the steps of FIG. 7;

FIG. 9 is a schematic view showing an example for calculating a curvature radius at a street cross point;

FIGS. 10A to 10C are schematic views showing examples for determining the abnormal condition according to the second embodiment;

FIGS. 11A to 11C are schematic views showing methods of identifying the curved roads;

FIG. 12 is a block diagram showing a vehicle control system having an engine ECU for performing a determination of an abnormal condition of a steering angle sensor, according to a third embodiment of the present invention;

FIG. 13 is a flowchart showing a process for determining the abnormal condition of the third embodiment;

FIG. 14 is a flowchart showing a process for setting a determination period, which is one of the steps of FIG. 13;

FIG. 15 is a graph showing a relation between a difference of right and left wheel speeds and a curvature radius of a road on which a vehicle is running;

FIGS. 16A to 16C are timing charts showing one example for setting the determination period, according to the third embodiment;

FIGS. 17A to 17C are timing charts showing one example for determining the abnormal condition, according to the third embodiment;

FIG. 18 is a schematic view showing steered angles of a vehicle at respective timing points of FIGS. 17A to 17C;

FIG. 19 is a flowchart showing a process for determining the abnormal condition according to a fourth embodiment;

FIG. 20 is a flowchart showing a process for setting the determination period, which is one of the steps of FIG. 19;

FIGS. 21A to 21C are timing charts showing one example for determining the abnormal condition, according to the fourth embodiment;

FIG. 22 is a flowchart showing a process for determining the abnormal condition according to a fifth embodiment;

FIG. 23 is a flowchart showing a process of interruption in the process of FIG. 22; and

FIG. 24 is a flowchart showing a process for determining the abnormal condition according to a further modification.

### DETAILED DESCRIPTION OF THE PREFERRED EMBODIMENTS

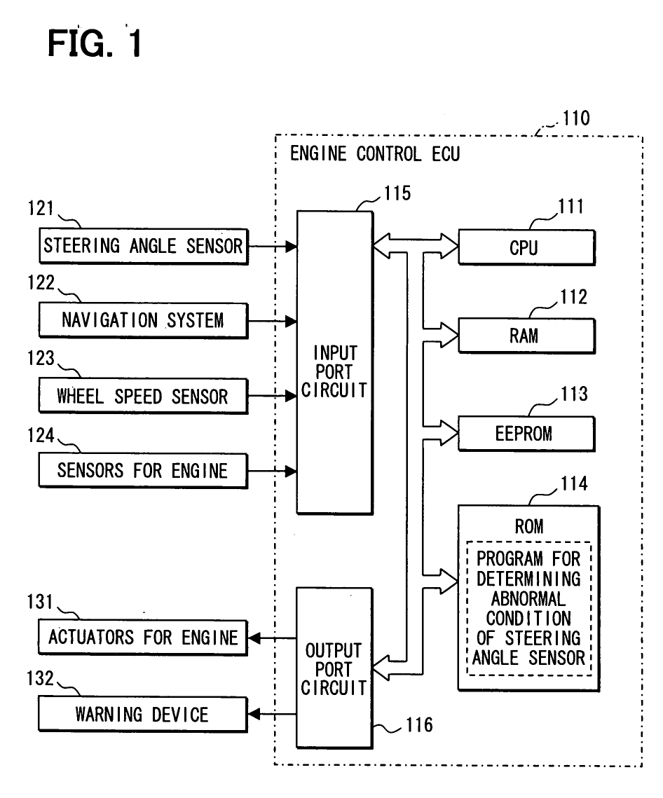

A first embodiment will be explained with reference to FIG. 1, in which an abnormal condition determining system for a steering angle sensor according to the present invention is embodied. In the embodiment, a signal of the steering angle sensor is used for an engine control system of a vehicle.

A structure of a vehicle control system, to which the abnormal condition determining system for the steering angle sensor according to the present invention is applied, will be explained with reference to FIG. 1.

As shown in FIG. 1, signals from various kinds of sensors (including a steering angle sensor 121) as well as signals from a car navigation system 122 are inputted to an engine control ECU (Electronic Control Unit) 110.

The engine control ECU 110 generally includes a microcomputer, which has CPU 111 for performing various calculations, RAM 112 as a main memory device, EEPROM 113 as a rewritable and a non-volatile memory, ROM 114 as another memory device, and so on. A program for the engine control, including a program for performing a determination of an abnormal condition of the steering angle sensor 121, is stored in the ROM 114. And various control data, including a design date for the engine, are stored in the EEPROM 113.

The engine control ECU 110 further has I/O ports, namely an input port circuit 115 and an output port circuit 116, for communicating (sending and receiving signals) with outside devices. To the input port circuit 115, signals from the various sensors and apparatuses, such as the steering angle sensor 121, the navigation system 122, a wheel speed sensor 123, sensors 124 for the engine, which are mounted in a vehicle, are inputted. From the output port circuit 116, signals are outputted to various kinds of actuators 131 for the engine, a warning device 132, and so on, which are mounted in the vehicle.

The steering angle sensor 121 detects a steered angle of a steering wheel operated by a vehicle driver. According to the embodiment, although not shown in the drawing, the steering angle sensor 121 has a sensor disc coaxially attached to a rotational shaft of the steering wheel and a photo-sensor (e.g. a photo-coupler), wherein the sensor disc has multiple slits circumferentially arranged at equal intervals and a notch for indicating a reference position (a center position of the steering wheel).

The navigation system 122 is generally composed of a micro computer for carrying out various kinds of data processing, for example, calculating a current position, a route searching and so on. The micro computer also controls input/output (I/O) processes to exchange the information with other control system or apparatuses related to the navigation system. The navigation system 122 further includes an input device for operation, a display device, a voice output device, an internal memory for storing map data, a GPS (Global Positioning System) receiver, a VICS (Vehicle Information and Communication System) receiver, an antenna for such receivers, and so on. Position information (the current position of the vehicle) obtained by a positioning function of the GPS, as well as other information, such as geographic information or traffic information obtained from the inside memory device and VICS, is outputted to the ECU 110 or to a user (e.g. a vehicle driver) through the output port circuit or a display device (not shown), as circumstances demand. The vehicle driver generally figures out, with precision, vehicle driving circumstances based on the above information. The vehicle driver searches a route to a destination by looking at the map displayed on the display device of the navigation system 122, or makes the navigation system 122 search the route. Accordingly, the vehicle driver can arrive at the destination without losing the way, because he can confirm the current position and/or the route to the destination.

The wheel speed sensor 123 detects a wheel speed of the vehicle wheel. According to the embodiment, the multiple wheel speed sensors 23 are provided at each of the vehicle wheels, so that wheel speed of the respective vehicle wheels can be detected.

The sensors 124 for the engine include sensors for an intake air pressure, an intake air temperature, an exhaust gas temperature, a throttle valve position, an engine cooling water temperature, a knocking condition, an air-fuel ratio of the intake air (an oxygen sensor), a crank angle position, and so on.

The actuators 131 for the engine include those actuators, such as a fuel injection valve, an ignition device, a heater for the oxygen sensor, an electronically controlled throttle valve, and soon. The warning device 132 is composed of, for example, a warning lamp which is turned on or turned off in accordance with an output signal from the ECU 110.

The ECU 110 is further connected with other electronic control systems, such as an anti-lock braking system (ABS), an automatic transmission system (AT), a traction control system (TRC), and so on, so that the ECU 110 communicates with those systems through a vehicle LAN being composed of CAN (Controller Area Network). A cooperative control among those electronic control systems can be carried out through the multiplex communication. For example, the anti-lock braking system (ABS) has a CPU and memory devices to prevent the vehicle from wheel lock by controlling braking fluid pressure based on the wheel speed sensors 123.

According to the present embodiment, the control programs stored in the ROM 114 is carried out by the ECU 110. For example, the engine control is carried out based on the output from the steering angle sensor 121, in such a way that a load fluctuation is compensated when the load fluctuation occurs as a result of the change of the steered angle. More exactly, well-known engine controls, such as the control for the fuel injection amount by the fuel injection valve, or the control for the ignition timing by the ignition device, are carried out depending on the load fluctuation (the change of the engine operational conditions).

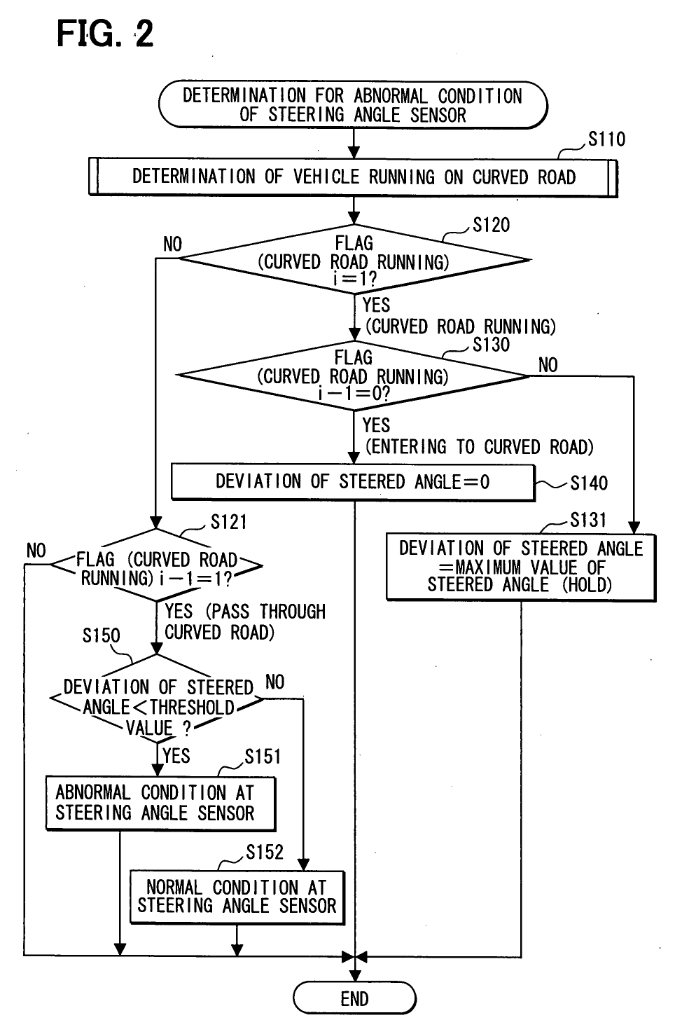

According to the embodiment, the engine control ECU 110 has a function to determine whether there is an abnormal condition for the steering angle sensor 121, in order to detect a disconnection or a short-circuit of a sensor wiring for the steering angle sensor 121 at an early stage, when such abnormal condition occurs. More exactly, the ECU 110 determines the abnormal condition of the steering angle sensor 121, when the ECU 110 detects a period for vehicle running on a curved street and when a maximum value of an output of the steering angle sensor 121 does not exceed a predetermined threshold value during the period of the vehicle running on the curved street. The determination of the abnormal condition is carried out by performing the program stored in the ROM 114, which will be explained more in detail with reference to FIGS. 2 to 6.

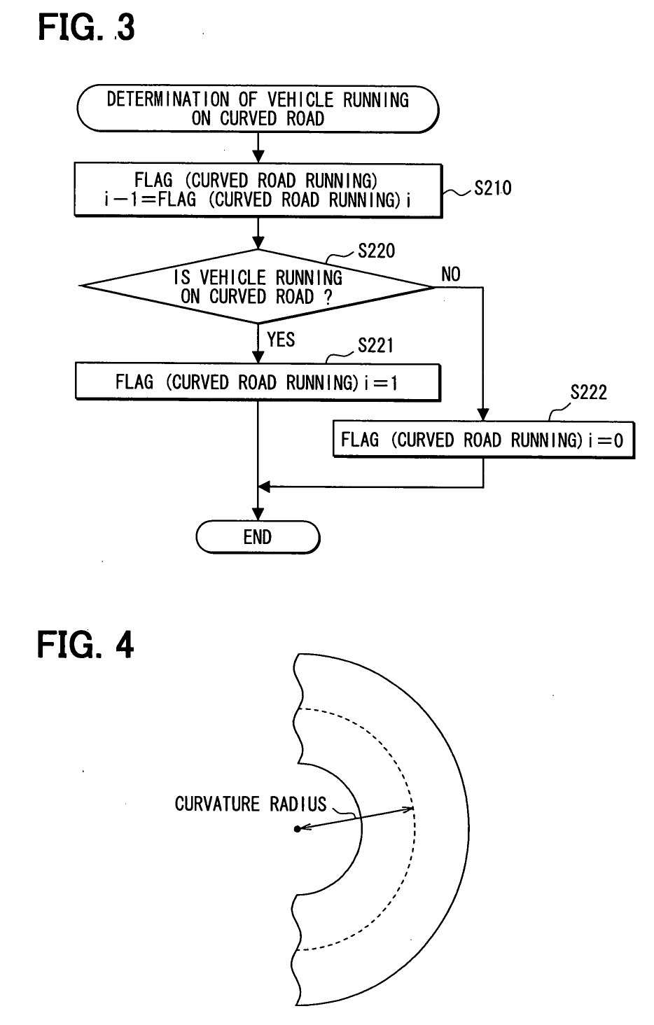

FIG. 2 is a flowchart showing a process for determining the abnormal condition of the steering angle sensor 121 according to the first embodiment, and FIG. 3 is a flowchart showing a process for determining a vehicle running on a curved road, which is one of the steps of FIG. 2 (a step S110). The program of FIG. 2 is repeatedly carried out at a predetermined interval (for example, at a predetermined cycle or at a predetermined crank angle). Each of parameters, which are used in the process of the program, is stored in the memory device (e.g. RAM 112, EEPROM 113) and renewed as needed.

At first, the process for determination of the vehicle running on the curved road is carried out at a step S110 of FIG. 2, namely in accordance with the program shown in FIG. 3.

At a step S210 of FIG. 3, a flag “Flag (Curved Road Running) i−1”, which shows data of a previous determination whether the vehicle was running on the curved road, is renewed. More exactly, the process for “Flag (Curved Road Running) i−1=Flag (Curved Road Running) i” is carried out, as shown in FIG. 3. In a case that the step S210 is carried out for the first time, for example, after a battery has been changed, the value of the previous determination does not exist. Therefore, in such a case, an initial value “0” is set to “Flag (Curved Road Running) i−1”.

At a step S220, the ECU 110 determines whether the vehicle is running on the curved road, that is, whether the road on which the vehicle is currently running is the curved road. More exactly, the ECU 110 calculates a curvature radius of the current road, based on the data for circumstances of the vehicle running, that is, the current position data and the geographical data from the navigation system 122. Then, the ECU 110 determines that the current road is the curved road, when the calculated curvature radius is smaller than a predetermined value (the curvature radius of the current road<the predetermined value). As shown in FIG. 4, the curvature radius shows a curving degree of a curved line. Therefore, as the curvature radius is smaller, the curving degree of the curved line becomes larger. As the curvature radius becomes larger, the curved line becomes closer to a straight line.

In the case that the ECU 110 determines at the step S220 that the current road is the curved road, the ECU 110 renews the content of the flag at the following step S221 to “Flag (Curved Road Running) i=1”. On the other hand, when the ECU 110 determines at the step S220 that the current road is not the curved road, the ECU 110 renews the content of the flag at the following step S222 to “Flag (Curved Road Running) i=0”. The process of FIG. 3 is then terminated.

Back to the flow chart of FIG. 2, the ECU 110 determines at a step S120 whether a condition for “Flag (Curved Road Running) i=1?” is satisfied or not. In the case that the condition for “Flag (Curved Road Running) i=1?” is not satisfied, the ECU 110 determines that the vehicle is running straight ahead on the road, and the process moves to a step S121, at which the ECU 110 determines whether a condition for “Flag (Curved Road Running) i−1=1?” is satisfied or not. Namely, the ECU 110 determines at the step S121 whether the vehicle has been running straight ahead or the vehicle has passed through the curved road. In case of “No” at the step S121, that is, when the vehicle has been running straight ahead on the road, the process of FIG. 2 is terminated. The process for steps S150, S151 and S152 will be explained later.

In case of “YES” at the step S120, that is, when the vehicle has is running on the curved road, the process goes to a step S130, at which the ECU 110 determines whether a condition for “Flag (Curved Road Running) i−1=0?” is satisfied or not. In case of “YES” at the step S130, the ECU 110 determines that the vehicle has entered from the straight road to the curved road (the ECU 110 determines that it is a “timing point of entering to a curved road” for the vehicle which has entered to the curved road). Then, the process goes to a step S140.

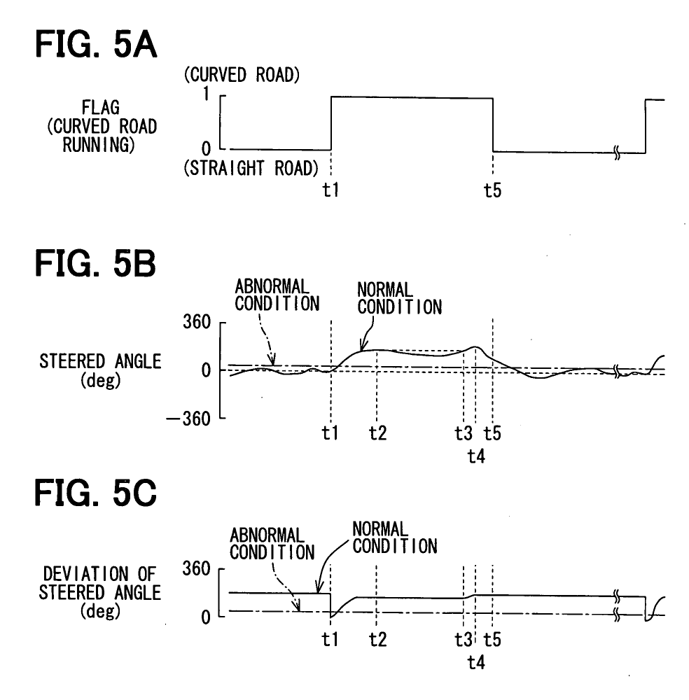

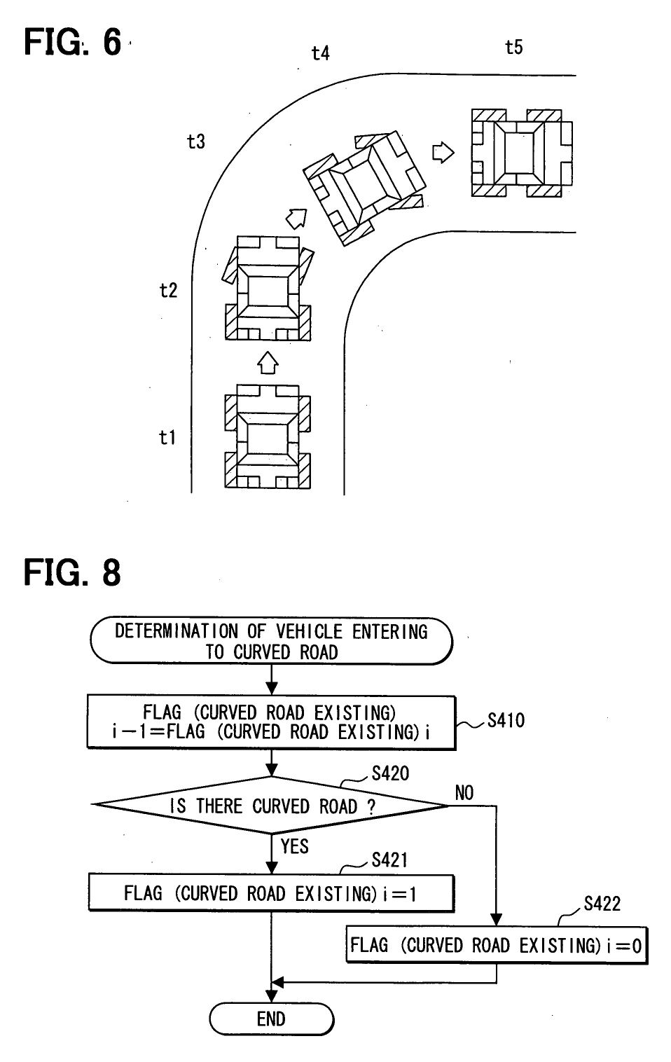

An explanation hereinafter is further made with reference to FIGS. 5A to 5C and 6. FIGS. 5A to 5C are timing charts showing one example for the abnormal condition of the steering angle sensor 121, wherein a solid line indicates the normal condition, whereas a one-dot-chain line indicates the abnormal condition. FIG. 5A indicates the value of the flag “Flag (Curved Road Running)”, FIG. 5B indicates an output (that is, a steered angle in degree) of the steering angle sensor 121, and FIG. 5C indicates a maximum value of the steering angle sensor 121 (a deviation of the steered angles in degree) during a period of vehicle running on the curved road. FIG. 6 is a schematic view visually showing steered angles of the vehicle at respective time points t1 to t5 of FIGS. 5A to 5C.

At a time point t1 of FIGS. 5A to 5C and 6 (i.e. a starting time point of the vehicle running on the curved road), the deviation of the steered angles is reset at the step S140 of FIG. 2 (the deviation of the steered angles is made zero). During the period of the vehicle running on the curved road, namely during the period from the time point t1 to the time point t5, the process of FIG. 2 is repeated. When the process goes to the step S130 through the steps S110 and S120 after the time point t1, the ECU 110 determines that the condition for “Flag (Curved Road Running) i−1=0?” is not satisfied. Accordingly, the process goes to a step S131, at which a maximum value of the steered angle is set (held) as the deviation of the steered angle. Then, the maximum value of the steered angle is continuously set (held) as the deviation of the steered angle at the step S131, until the time point t5 at which the vehicle passes through the curved road.

During the period from the time point t1 to the time point t5, which corresponds to the period of the vehicle running on the curved road, the maximum value of the steered angle is held as the deviation of the steered angle, as shown by the solid line in FIG. 5C. More exactly, even when the steered angle is saturated and starts to decrease at the time point t2, the deviation of the steered angle is not decreased, so that the maximum value of the steered angle is held as the deviation of the steered angle. Then at the time point t3, at which the steered angle starts to increase and goes over the saturated value, the deviation of the steered angle is also increased. At the time point t4, at which the steered angle is saturated again, the maximum value of the steered angle is likewise held as the deviation of the steered angle.

When the vehicle passes through the curved road at the time point t5, the ECU 110 determines at the step S120 that the vehicle is running straight forward, so that the process goes to the step S121. The ECU 110 determines at the step S121 that the vehicle has passed through the curved road, so that the process goes to the step S150. The ECU 110 compares at the step S150 whether the deviation of the steered angle, that is, the maximum value of the steered angle (the maximum value of the output from the sensor 121), during the period of the vehicle running on the curved road, with a predetermined threshold value. Namely, the ECU 110 determines whether a condition for “the deviation of the steered angle<the predetermined threshold value?” is satisfied. In the case that the above condition is satisfied at the step S150, namely in the case that the deviation of the steered angle is lower than the predetermined threshold value, the ECU 110 determines the abnormal condition of the steering angle sensor 121, so that the process goes to the step S151 at which the warning lamp 132 is turned on. The ECU 110 determines the abnormal condition of the steering angle sensor 121, because the output from the sensor 121 does not go over the threshold value, even in spite that the vehicle has passed through the curved road (as shown by the one-dot-chain line in FIGS. 5B and 5C).

In the case that the condition for the step S150 is not satisfied, namely when the deviation of the steered angle is larger than the predetermined threshold value, the ECU 110 determines the normal condition of the steering angle sensor 121 at the step S152, because there is a normal reaction from the steering angle sensor 121 during the vehicle is running on the curved road, as shown by the solid line in FIG. 5B.

According to the first embodiment, the process of FIG. 2 is repeatedly carried out at the predetermined cycle (at the predetermined crank angle), so that the starting time point t1 (at which the vehicle enters into the curved road) as well as the ending time point t5 (at which the vehicle passed through the curved road) can be detected. Therefore, the period (t1 to t5) of the vehicle running on the curved road can be detected with precision. The ECU 110 determines whether there is the abnormal condition for the steering angle sensor 121, based on the comparison between the maximum value of the sensor output during the above period (t1 to t5) and the predetermined threshold value. As a result, the ECU 110 detects the abnormal condition of the steering angle sensor 121 at the earlier stage.

The above embodiment has the following advantages.

According to the above first embodiment, the determination for the abnormal condition of the steering angle sensor 121 can be easily (simply) but accurately carried out, even in a vehicle in which the yaw-rate sensor or any other sensor similar to the yaw-rate sensor is not provided.

The determination for the abnormal condition of the steering angle sensor 121 can be carried out with high precision, without depending on the vehicle speed.

The abnormal condition of the steering angle sensor 121 is determined, when the maximum value of the output from the steering angle sensor 121 does not exceed the predetermined threshold value during the period of the vehicle running on the curved road. The maximum value of the output from the steering angle sensor 121 is held, irrespectively how the steering wheel is operated by the vehicle driver during the period of the vehicle running on the curved road. Accordingly, it becomes easier and simpler to determine the abnormal condition of the steering angle sensor by comparing with the predetermined threshold value, after the period of the vehicle running on the curved road.

The determination of the vehicle running on the curved road is carried out from point to point. Therefore, the detection for the period of the vehicle running on the curved road can be carried out with precision.

### Second Embodiment

A second embodiment will be explained with reference to the drawings. The abnormal condition determining system of the second embodiment is also applied to the vehicle control system. The system structure is the same to that of the first embodiment. An explanation for the system structure is omitted. Different points and features from the first embodiment will be mostly explained.

According to the second embodiment, the period of the vehicle running on the curved road is likewise detected by use of the information for the current position of the vehicle as well as the geographical information from the navigation system 122. And the determination for the abnormal condition of the steering angle sensor 121 is carried out when the maximum value of the output from the steering angle sensor 121 during the above period does not exceed the predetermined threshold value, as in the same manner to the first embodiment.

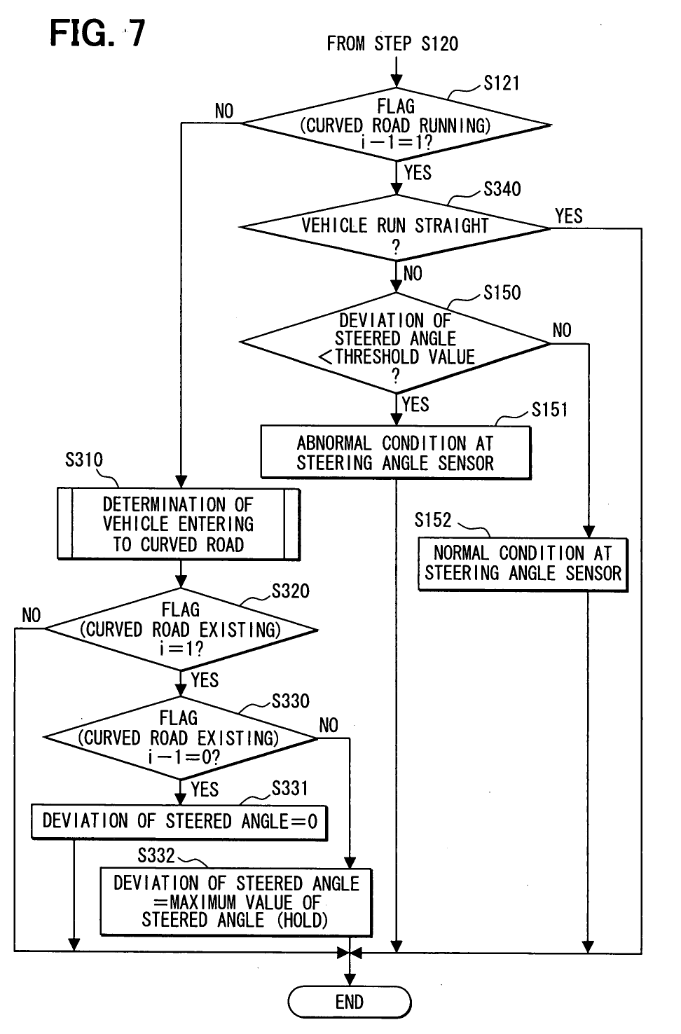

FIG. 7 is a flowchart showing a process for determining the abnormal condition of the steering angle sensor 121 according to the second embodiment. The steps S110 to S140 and S131 (FIG. 2) are the same in the first and second embodiments. Those steps are therefore not shown in FIG. 7. FIG. 8 is a flowchart showing a process for determining a vehicle entering to a curved road, which is one of the steps of FIG. 7. The determination of the abnormal condition is carried out by performing the program stored in the ROM 114. Each of parameters, which are used in the process of the program, is stored in the memory device (e.g. RAM 112, EEPROM 113) and renewed as needed.

The programs of FIG. 2, FIG. 7, and FIG. 8 are also repeatedly carried out at the predetermined interval (for example, at the predetermined cycle or at the predetermined crank angle). When the vehicle is running straight ahead, the ECU 110 determines at the step S121 that the condition for “Flag (Curved Road Running) i−1=1?” is not satisfied, and the process goes to a step S310 of FIG. 7. Then, the ECU determines whether the vehicle has entered into the curved road in accordance with the process shown in FIG. 8.

At a step S410 of FIG. 8, a flag “Flag (Curved Road Existing) i−1”, which shows data of a previous determination whether there is a curved road in the direction of the vehicle traveling, is renewed. More exactly, the process for “Flag (Curved Road Existing) i−1=Flag (Curved Road Existing) i” is carried out, as shown in FIG. 8. In the case that the step S410 is carried out for the first time, for example, after the battery has been changed, the value of the previous determination does not exist. Therefore, in such a case, an initial value “0” is set to “Flag (Curved Road Existing) i−1”.

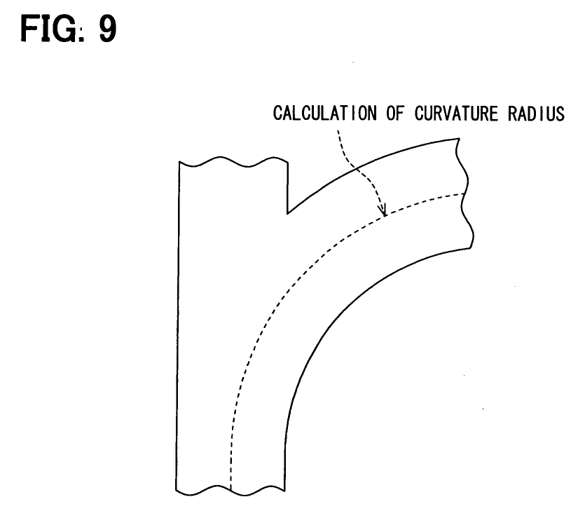

At a step S420, the ECU determines whether there is a curved road in the direction of the vehicle traveling. More exactly, the ECU 110 calculates a curvature radius of a road, on which the vehicle is going to run in near future, based on the data for circumstances of the vehicle running, that is, the current position data and the geographical data from the navigation system 122. Then, the ECU 110 determines that the road ahead in the vehicle running direction is the curved road, when the calculated curvature radius is smaller than a predetermined value (the curvature radius of the road ahead in the vehicle running direction<the predetermined value). In case of an intersection having multiple roads (for example, a cross point, three-forked roads, forked roads having more than five roads, two-forked roads), the ECU 110 determines whether there is a curved road ahead or not, for such a road having the smallest curvature radius, as shown in FIG. 9.

In the case that the ECU 110 determines at the step S420 that there is a curved road ahead in the direction of the vehicle traveling, the ECU 110 renews the content of the flag at the following step S421 to “Flag (Curved Road Existing) i=1”. On the other hand, when the ECU 110 determines at the step S420 that there is no curved road ahead in the direction of the vehicle traveling, the ECU 110 renews the content of the flag at the following step S422 to “Flag (Curved Road Existing) i=0”. The process of FIG. 8 is then terminated.

Back to the flow chart of FIG. 7, the ECU 110 determines at a step S320 whether a condition for “Flag (Curved Road Existing) i=1?” is satisfied or not. In the case that the condition for “Flag (Curved Road Existing) i=1?” is not satisfied, the ECU 110 determines that the vehicle is still running on the straight road, and the process moves to an end. On the other hand, when the condition for “Flag (Curved Road Existing) i=1?” is satisfied at the step S320, the process goes to a step S330, at which the ECU 110 determines whether a condition for “Flag (Curved Road Existing) i−1=1?” is satisfied or not. In case of “YES” at the step S330, the ECU 110 determines that the vehicle is going to enter from the straight road to the curved road in the very near future (therefore, the ECU 110 determines that it is a “time point of entering to the curved road” for the vehicle which is going to enter to the curved road). Then, the process goes to a step S331 to reset the deviation of the steered angle (the deviation of the steered angle=0). As a result, a period for the vehicle running on the curved road starts.

The process of FIG. 7 as well as the process of FIG. 2 is repeatedly carried out even during the period of the vehicle running on the curved road. Therefore, the process goes to the step S130 again through the steps S110 and S120 at the next cycle, then the ECU 110 determines at the step S130 that the condition for “Flag (Curved Road Existing) i−1=0?” is not satisfied. Accordingly, the process repeatedly goes to a step S131 thereafter, at which the maximum value of the steered angle is set (held) as the deviation of the steered angle. Thus, the maximum value of the steered angle is repeatedly set (held) as the deviation of the steered angle at the step S131, until the vehicle passes through the curved road. The above process for holding the maximum value of the steered angle as the deviation of the steered angle is basically the same to that of the first embodiment.

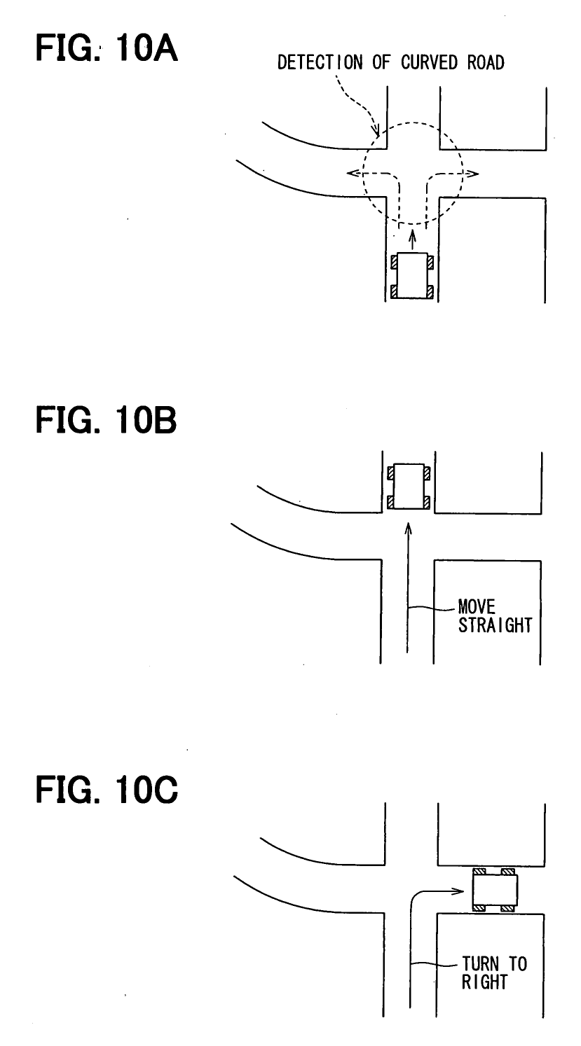

When the vehicle has passed through the curved road, the ECU 110 determines at the step S121 that the condition “Flag (Curved Road Running) i−1=1?” is satisfied, so that the process goes to a step S340. The ECU 110 determines at the step S340 whether the vehicle has moved straight forward. For example, in the case that the curved road, which has been determined at the step S420 of FIG. 8, is one of roads at the intersection having a straight road, as shown in FIG. 10A, there is a possibility that the vehicle is running straight even after the vehicle has passed through the intersection. Accordingly, the ECU 110 determines at the step S340, based on the data of the current position of the vehicle as well as the geographical data of the navigation system 122, whether the vehicle has run straight as shown in FIG. 10B, or whether the vehicle has turned to the right (or the left) as shown in FIG. 10C. In the case that the curved road, which has been determined at the step S420 of FIG. 8, is one of roads at the intersection having no straight road, the ECU 110 determines at the step S340 that the vehicle has turned (the vehicle has not run straight).

When the ECU 110 determines at the step S340 that the vehicle has run straight, the ECU 110 does not carry out any step for the determination of the abnormal condition. The process is terminated without carrying the determination.

When the ECU 110 determines at the step S340 that the vehicle has turned to the right or left, the process goes to the steps S150 and S151 or S152, at which the ECU 110 carries out the determination of the normal or abnormal condition of the steering angle sensor, as in the same manner to the first embodiment (FIG. 2).

According to the second embodiment, the processes of FIG. 2 and FIG. 7 are repeatedly carried out at the predetermined cycle (at the predetermined crank angle) as already explained, so that the starting time point (at which the vehicle enters into the curved road) can be detected without delay, by detecting the curved road ahead in the direction of the vehicle traveling. The ECU 110 determines whether there is the abnormal condition for the steering angle sensor 121, based on the comparison between the maximum value of the sensor output during the above period and the predetermined threshold value. As a result, the ECU 110 detects the abnormal condition of the steering angle sensor 121 at the earlier stage, as in the same manner to the first embodiment. The changes of the parameters (the steered angle, the deviation of the steered angle) are also similar to those in the timing chart of FIG. 5.

The second embodiment has the following advantages, in addition to those for the first embodiment.

The starting time point for the period of the vehicle running on the curved road (the time point of the vehicle entering to the curved road) is determined (at the steps S310 to S330, S331, S332) based on the determination of the curved road ahead in the vehicle running direction. Therefore, the starting time point for the period of the vehicle running on the curved road can be accurately detected without delay.

The ECU 110 has the program for determining whether the vehicle has passed through the intersection with or without turning, based on the data for the current position of the vehicle as well as the geographical data from the navigation system 122, when the intersection has the straight road and the curved road. Then, the ECU 110 decides, based on the result of the above determination (the step S340), that the determination whether the change of the output from the sensor has a sufficient amount (higher than the threshold value) should be carried out or not, when the ECU 110 determined that the vehicle has turned (the vehicle has run on the curved road). Accordingly, the detection that the vehicle has passed through the intersection can be done with high precision. And as a result thereof, an erroneous determination for the abnormal condition of the steering angle sensor can be avoided.

### Modifications of the First and/or Second Embodiments

In the above second embodiment, the ECU 110 determines according to the program (the program for determining the vehicle straight running) whether the vehicle has passed through the intersection with or without turning, based on the data for the current position of the vehicle as well as the geographical data from the navigation system 122. However, the ECU 110 may alternatively determine whether the vehicle has passed through the intersection and whether the vehicle has turned at the intersection, based on the vehicle running condition, such as the vehicle speed.

In the above second embodiment, the period for the vehicle running on the curved road is detected by determining from point to point whether the road on which the vehicle is running is the curved road or not. In a vehicle having the above program for determining the vehicle straight running, the detection for the end of the period for the vehicle running on the curved road (i.e. the time point at which the vehicle has passed through the curved road) can be done more easily. For example, the end of the period for the vehicle running on the curved road can be detected, when the ECU 110 detects the straight road existing ahead in the direction of the vehicle running based on the data for the current position of the vehicle as well as the geographical data from the navigation system 122.

In the above embodiments, the determination for the abnormal condition (the step S150) is basically carried out at all curved roads. However, the curved roads may be selected in advance, for which the determination for the abnormal condition should be carried out. In such a case, the process for detecting the curved roads (for example, the step S410 of FIG. 8) may be carried out only when the vehicle is coming closer to such an area of the selected roads. Such kinds of selection of the roads can be easily done by use of one of functions of the navigation system. In such a case (the determination in the selected roads), the efficiency for detecting the abnormal condition can be increased. Furthermore, in the case that such curved roads are selected, for which the determination of the curved road can be easily done, it becomes possible to suppress a possibility of the erroneous determination. In addition, in the case that the determination of the curved road is carried out for such a road having one track (without any forked roads), the process for determining the curved road can be simplified, because the program for such process may not need any steps for detecting the intersections.

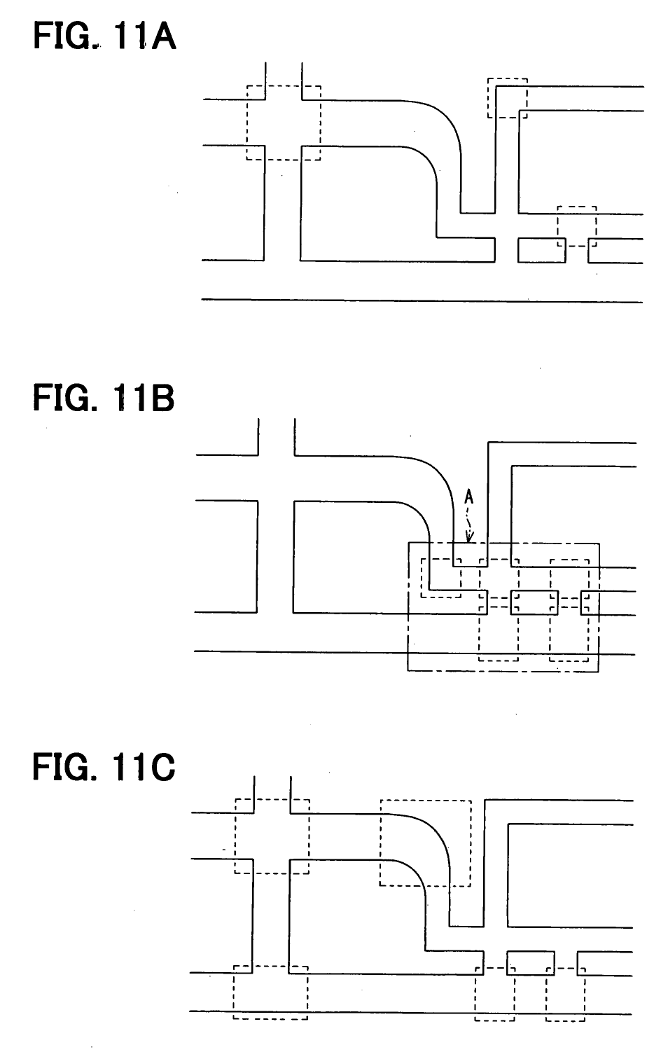

There are many methods for selecting the curved roads, which depend on the applications or specifications of the steering angle sensor 121, the driver's preference, and so on. For example, as shown in FIG. 11A, the curved roads may be selected by the user (the vehicle driver) on the map of the navigation system 122. Three curved roads are selected in FIG. 11A, as indicated by dotted lines. According to such method, the curved roads can be selected by the user at its option. As another example, as shown in FIG. 11B, an area may be selected by the user on the map of the navigation system 122. An area. A indicated by a one-dot-chain line is selected. The curved roads are then selected when the curved roads are included in the area A. In case of FIG. 11B, five curved roads indicated by the dotted lines within the area A are selected as the curved roads. According to such method, the curved roads in a neighboring area or a commuting area can be easily selected. As a further alternative method, as shown in FIG. 11C, the curved roads meeting the predetermined conditions (for example, a width of the road) may be automatically selected. In FIG. 11C, the curved roads having the road width larger than the predetermined value (five curved roads indicated by the dotted lines) are selected. According to such a method, the trouble of the user for selecting the curved roads can be saved.

The curvature radius (the curving degree) can be expressed by not only in the radius but in an angle.

In the above embodiments, the maximum value of the sensor output (the deviation of the steered angle) during the period of the vehicle running on the curved road is compared with the predetermined threshold value, for the purpose of determining the abnormal condition of the steering angle sensor 121. Instead of the maximum value, however, an integrated value of the sensor output during the above period may be used for the comparison.

Furthermore, the determination for the curved roads may be carried out without using the above maximum value or the integrated value. For example, a transition of the sensor output is recorded as a graph, and it may be determined whether there is a certain amount of change in the sensor outputs based on analysis of the graph.

According to the invention, the determination for the abnormal condition of the steering angle sensor can be simply and accurately carried out, when there is basically provided with the following two programs; the program for detecting that the vehicle has passed through the curved road by use of the data for the vehicle current position as well as the geographical data from the navigation system, and the program for determining the abnormal condition of the steering angle sensor when the output change does not have the certain amount, in spite that the above first program determined that the vehicle had passed through the curved road.

The threshold value (the step S150) for the determination of the abnormal condition may not be limited to a fixed amount. For example, a program may be added to the above explained embodiments, wherein the threshold value maybe changed depending on the curvature radius of the curved road, which is the subject for the period of the vehicle running on the curved road. According to such program, an acceptable level for the determination of the abnormal condition can be maintained as an appropriate value, without depending on the curvature radius. As a result, the determination of the abnormal condition can be carried out more accurately.

The above threshold value may be alternatively changed depending on a length of the curved road. In the case that the integrated value of the sensor output during the period of the vehicle running on the curved road is compared with the threshold value, the integrated value of the sensor output becomes larger as the length of the road is larger, namely the period of the vehicle running on the curved road is longer. Accordingly, it is more preferable to use the integrated value in such a situation.

In the above embodiments, the car navigation system is used as the navigation system. However, other types of the navigation systems, such as a portable type or a communication type navigation system, maybe also used. A beacon receiver, a mobile communication device, a broadcasting receiver, and so on may be used as a device for positioning the current position, instead of the GPS receiver. The geographical data may be obtained from another computer or may be downloaded from the recording medium. The above devices and methods, according to which the data for the current position of the vehicle as well as the geographical data can be obtained, may be used as modifications of the navigation system.

In the above embodiments, the data for the current position of the vehicle as well as the geographical data of the navigation system 122 are used when detecting the curved roads. However, the determination for the abnormal condition of the steering angle sensor can be carried out without using the geographical data. For example, a first program is added to the ECU 110 and a vehicle running track is obtained from the data for the current position of the vehicle, wherein the ECU 110 detects in accordance with the first program that the vehicle running track has plotted a curved line. Then, the ECU 110 determines the abnormal condition of the steering angle sensor according to a second program, when the output change of the steering angle sensor does not have the certain amount, in spite that the above first program determined that the vehicle running track has plotted the curved line. Namely, the vehicle behavior is detected from point to point by use of the data for the current position of the vehicle of the navigation system 122, so that the ECU 110 may determine whether the vehicle running track has plotted the curved line. Based on the above vehicle behavior, it is possible to detect a period which corresponds to the period of the vehicle running on the curved road. According to such method for determining the abnormal condition of the steering angle sensor, not the geographic data but the data for the vehicle current position is used, so that the determination process can be further simplified.

The above system for determining the abnormal condition of the steering angle sensor may be further used together with the system (e.g. the system disclosed in Japanese Patent No. 3,161,303) having the yaw-rate sensor for determining the abnormal condition of the steering angle sensor. In such a case (in a combination of the two systems), as different determination processes are carried out, the accuracy for determining the abnormal condition can be increased. Furthermore, in the above combined system, the determination of the abnormal condition may be carried out in association with the navigation system, when the vehicle speed is low, at which the accuracy for the determination process by use of the yaw-rate sensor is not high (the erroneous determination may be likely to occur).

According to the invention, the determination of the abnormal condition can be carried out for any kinds of structures for the steering angle sensor 121.

In the above embodiments, the steering angle sensor is used for the purpose of correcting the engine load. The present invention can be applied to any kinds of the applications for the steering angle sensors. For example, the invention can be applied to the steering angle sensor, which is applied to the steering control.

In the above embodiments, the system for determining the abnormal condition of the steering angle sensor is mounted in the engine control ECU 110. However, the system may be mounted in other control ECUs for the vehicle, for example in the steering control ECU.

In the above embodiments, the programs (software) are provided to perform the function of determining the abnormal condition of the steering angle sensor. However, hardware may be provided to perform the same function.

In the above embodiments, the warning lamp 132 is turned on, when the ECU 110 determines the abnormal condition (at the step S151) Instead of displaying the abnormal condition by the warning lamp, it is also possible to memorize a diagnosis code corresponding to such abnormal condition in the memory device, for example, in the EEPROM 113.

### Third Embodiment

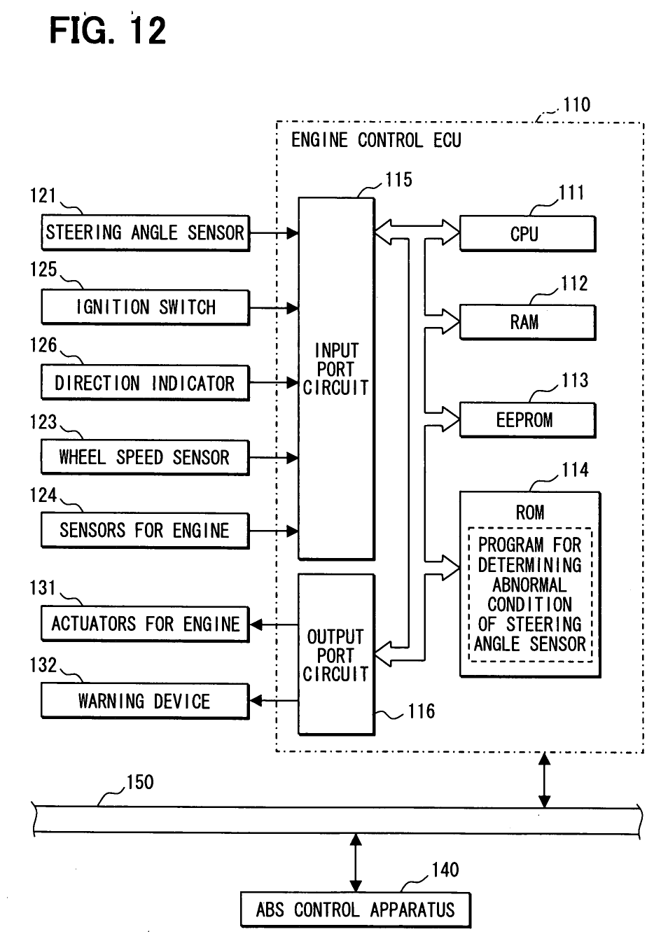

A third embodiment will be explained with reference to FIG. 12, in which an abnormal condition determining system for the steering angle sensor according to the present invention is embodied. In the embodiment, a signal of the steering angle sensor is used for an engine control system of a vehicle having an ABS (Anti-lock Braking System) system.

A structure of a vehicle control system (FIG. 12), to which the abnormal-condition determining system for the steering angle sensor according to the present invention is applied, is similar to that of the first embodiment shown in FIG. 1. Therefore, different points between the first and third embodiments will be mostly explained. Signals indicating operations of an ignition switch 125 and a direction indicator 126 are inputted to the ECU 110. The ECU 110 is connected with an anti-lock braking system (ABS) 140, through a vehicle LAN 150 being composed of CAN (Controller Area Network). The same reference numerals in FIG. 12 designate the same or similar parts and/or devices to those in FIG. 1.

The ignition switch 125 is a switch for an ignition operation and for starting an engine operation, wherein the ignition switch 125 is turned on and off by a key operated by a user (the vehicle driver). When the key is inserted into a key cylinder and rotated to a first position, a steering lock is released, the electric power is supplied to vehicle accessories such as a radio at a second position, and the electric power is supplied to an ignition device at a third position. When the ignition key is further rotated to a fourth position, a starter motor is rotated to drive a crankshaft to start the engine.

The direction indicator switch 126 is a switch, which is automatically turned off when a steering wheel is returned from a steered position (a vehicle turning position) to a neutral position (a straight running position). Multiple indicator lamps are mounted to front and rear sides of a vehicle body, in order to indicate a direction of the vehicle turning by blinking the lamps. In this direction indicating device, a lever-type switch is operated by the vehicle driver, so that the indicator lamp is turned on, and the lever-type switch is automatically turned off when the steering wheel returns to the neutral position. The direction indicator switch 126 can be turned off by the operation of the vehicle driver, irrespectively whether the steering wheel returns to the neutral position. For the purpose of the present invention, not only the signals indicating the switching condition (turned-on or turned-off condition) for the direction indicator switch 126 but also a signal, which indicates whether the direction indicator switch 126 is automatically turned off as a result of the steering wheel returning to the neutral position, is inputted to the input port circuit 115.

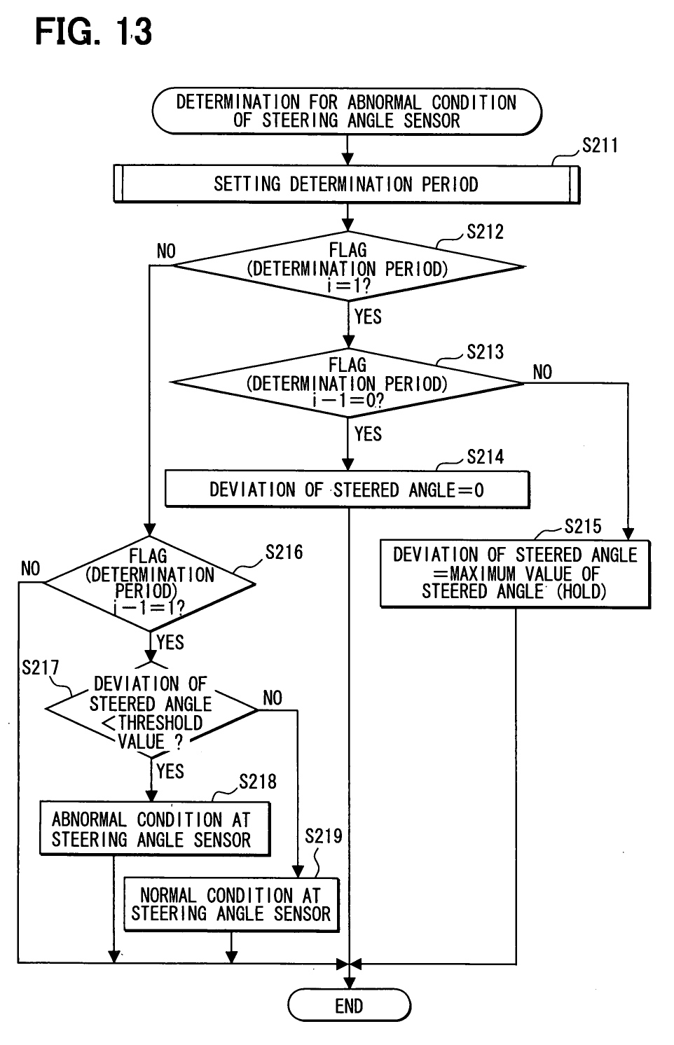

According to the embodiment, the engine control ECU 110 has a function to determine whether there is an abnormal condition for the steering angle sensor 121, in order to detect a disconnection or a short-circuit of a sensor wiring for the steering angle sensor 121 at an early stage, when such abnormal condition occurs. More exactly, the ECU 110 automatically sets a determination period based on a difference of a wheel speed between right and left vehicle wheels at a vehicle turning, wherein the ECU 110 determines during the determination period whether the output from the steering angle sensor 121 is in a normal range. The ECU 110 determines that the steering angle sensor 121 is abnormal, when the output change of the steering angle sensor 121 does not exceed a predetermined threshold value during the determination period. The determination of the abnormal condition is carried out by performing a program (a determination program for the abnormal condition of the sensor) stored in the ROM 114, which will be explained more in detail with reference to FIGS. 13 to 18.

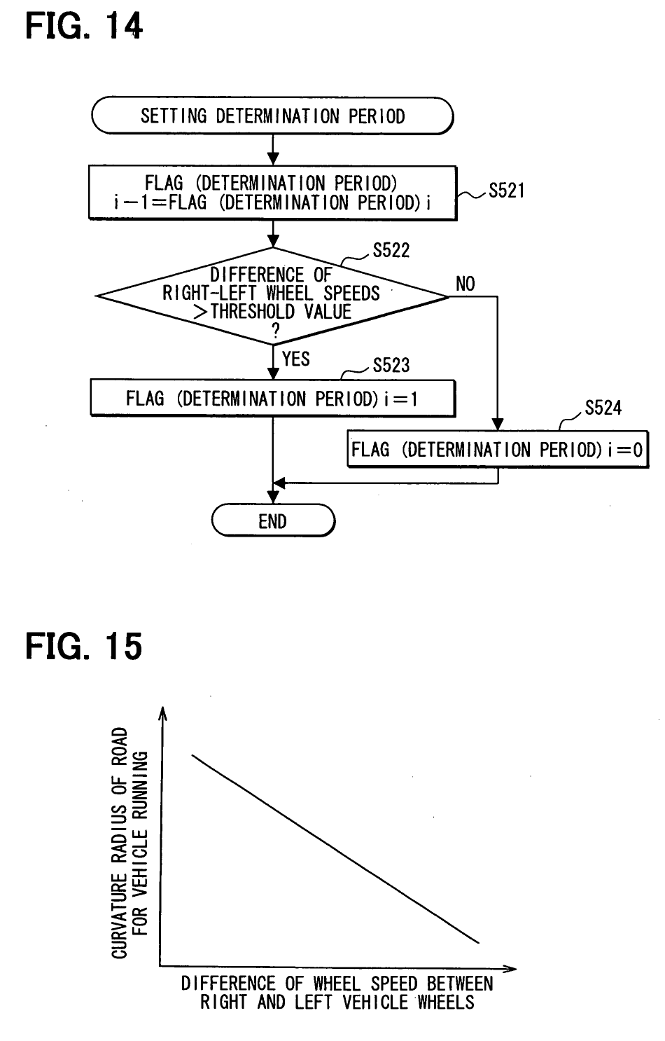

FIG. 13 is a flowchart showing a process for determining the abnormal condition of the steering angle sensor 121 according to the third embodiment, and FIG. 14 is a flowchart showing a process for setting the determination period, which is one of the steps of FIG. 13 (a step S211). The program of FIG. 13 is repeatedly carried out at a predetermined interval (for example, at a predetermined cycle or at a predetermined crank angle). Each of parameters, which are used in the process of the program, is stored in the memory device (e.g. RAM 112, EEPROM 113) and renewed as needed.

At first, the process for setting the determination period is carried out at the step S211 of FIG. 13, namely in accordance with the program shown in FIG. 14.

At a step S521 of FIG. 14, a flag “Flag (Determination Period) i−1”, which shows data of a previous cycle whether the previous cycle was in the determination cycle, is renewed. More exactly, the process for “Flag (Determination Period) i−1=Flag (Determination Period) i” is carried out, as shown in FIG. 14. In a case that the step S521 is carried out for the first time, for example, after a battery has been changed, the value of the previous determination does not exist. Therefore, in such a case, an initial value “0” is set to “Flag (Determination Period) i−1”.

At a step S522, the ECU 110 calculates the difference of the wheel speed between the right and left vehicle wheels based on the wheel speeds of the respective vehicle wheels obtained from the wheel speed sensors 123. Then, the ECU 110 compares the difference of the wheel speed with a predetermined threshold value. When the ECU 110 determines through the above comparison that the difference of the wheel speed is larger than a predetermined threshold value (the difference of the wheel speed>the predetermined threshold value), the ECU 110 renews the content of the flag at the following step S523 to “Flag (Determination Period) i=1”. “Flag (Determination Period) i=1” means that it is in the determination period. On the other hand, when the ECU 110 determines at the step S522 that the difference of the wheel speed is smaller than the predetermined threshold value, the ECU 110 renews the content of the flag at the following step S524 to “Flag (Determination Period) i=0”. The process of FIG. 14 is then terminated. The predetermined threshold value used in the above step S522 corresponds to a maximum value among the differences of the wheel speed between the right and left vehicle wheels when the vehicle is running straight.

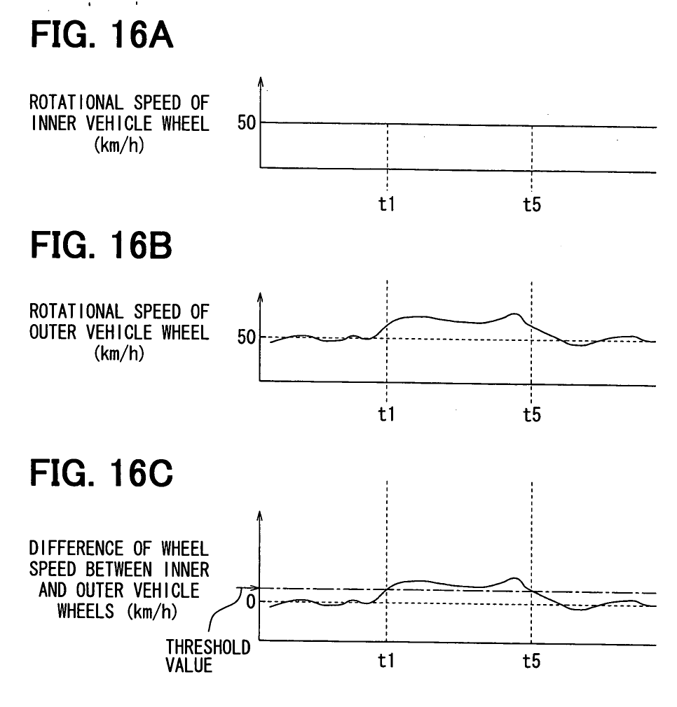

The process for setting the determination period will be explained more in detail with reference to FIGS. 15 and 16A to 16C.

FIG. 15 is the graph showing the relation between the difference of right and left wheel speeds and a curvature radius of a road on which the vehicle is running.

As shown in FIG. 15, the above two parameters (the difference of the wheel speed and the curvature radius) have the relation, in that the curvature radius becomes smaller (a sharper curve) as the difference of the right and left wheel speeds becomes larger. Therefore, it is possible to determine whether the vehicle is running straight or running on a curved road, based on the difference of the right and left wheel speeds.

FIGS. 16A to 16C are timing charts showing one example for setting, the determination period. FIG. 16A shows a wheel speed (km/h) of an inner vehicle wheel during a vehicle turning (for example, a right-hand vehicle wheel in case of the vehicle turning to the right), FIG. 16B shows a wheel speed (km/h) of an outer vehicle wheel during the vehicle turning (for example, a left-hand vehicle wheel in case of the vehicle turning to the right), and FIG. 16C shows a difference (km/h) of those wheel speeds between the inner and outer vehicle wheels. In FIGS. 16A to 16C, t1 corresponds to a starting time point of the determination period, t5 corresponds to an end of the determination period, and a period between t1 to t5 corresponds to the determination period.

As shown in FIG. 16C, the ECU 110 determines that the vehicle is running on the curved road, when the difference of the right and left wheel speed becomes larger than the threshold value (the maximum value of the difference of the wheel speed during the vehicle running on the straight road). The starting time point t1 is automatically set by the process (determination) at the step S523. The ECU 110 determines that the vehicle is running on the straight road, when the difference of the right and left wheel speed becomes smaller than the threshold value, so that the end (t5) of the determination period is automatically set by the process (determination) at the step S524. Thus, the determination period is decided and automatically set according to the embodiment.

Back to the flowchart of FIG. 13, the ECU 110 determines at a step S212 whether a condition for “Flag (Determination Period) i=1?” is satisfied or not. In the case that the condition for “Flag (Determination Period) i=1?” is not satisfied, the ECU 110 determines that it is out of the determination period, and the process moves to a step S216, at which the ECU 110 determines whether a condition for “Flag (Determination Period) i−1=1?” is satisfied or not. Namely, the ECU 110 determines at the step S216 whether it is before or after the determination period, based on a result satisfying or not satisfying the condition of the step S216. In case of “No” at the step S216, that is, it is before the determination period, the process of FIG. 13 is terminated. The process for steps S217, S218 and S219 will be explained later.

In case of “YES” at the step S212 (that is, it is in the determination period), the process goes to a step S213, at which the ECU 110 determines whether a condition for “Flag (Determination Period) i−1=0?” is satisfied or not. In case of “YES” at the step S213, the ECU 110 determines that it is the starting time point “t1”. Then, the process goes to a step S214.

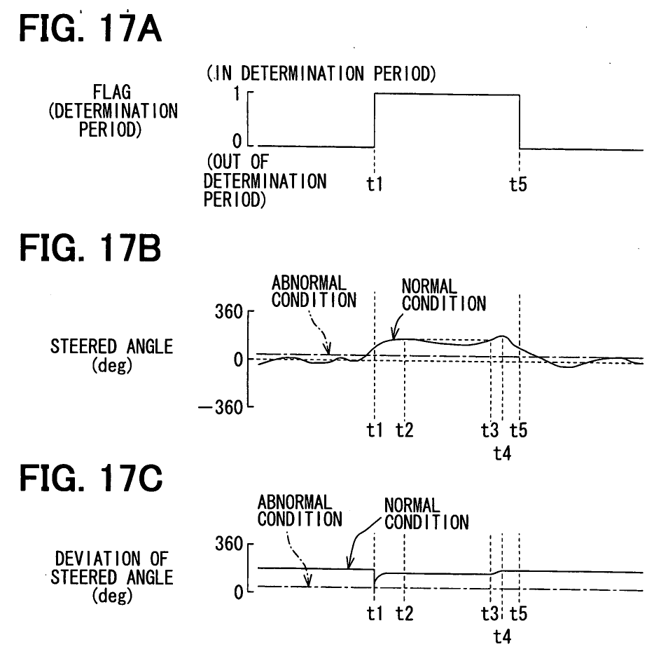

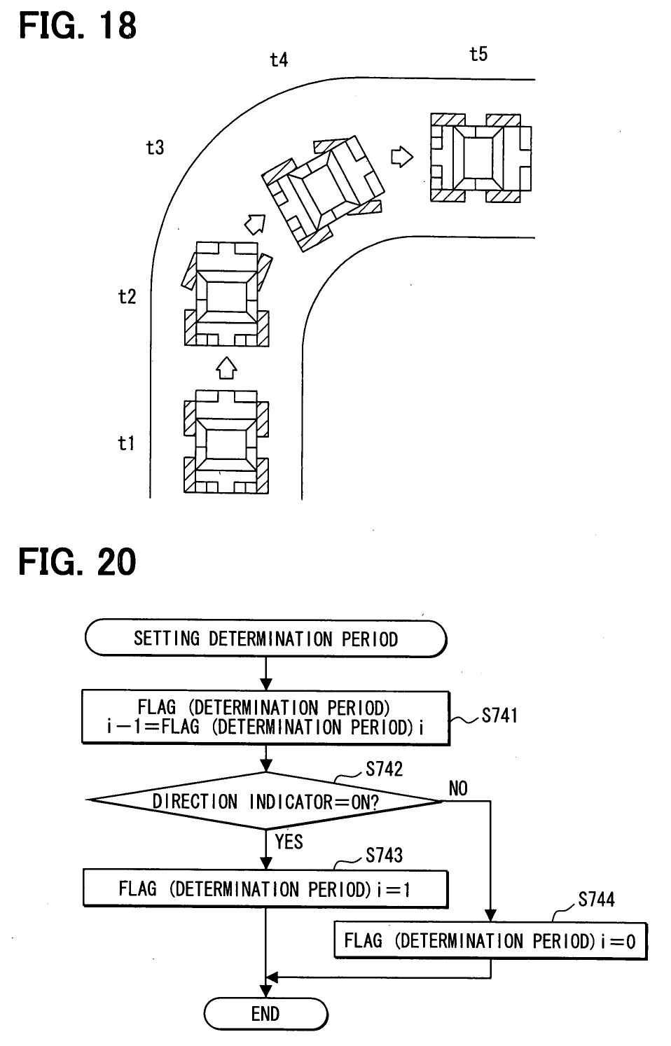

An explanation hereinafter is further made with reference to FIGS. 17A to 17C and 18. FIGS. 17A to 17C are timing charts showing one example for the abnormal condition of the steering angle sensor 121, wherein a solid line indicates the normal condition, whereas a one-dot-chain line indicates the abnormal condition. FIG. 17A indicates the value of the flag “Flag (Determination Period)”, FIG. 17B indicates an output (that is, a steered angle in degree) of the steering angle sensor 121, and FIG. 17C indicates a maximum value of the steering angle sensor 121 (a deviation of the steered angles in degree) during the determination period. FIG. 18 is a schematic view visually showing steered angles of the vehicle at respective time points t1 to t5 of FIGS. 17A to 17C.

At the starting time point t1 of the determination period (FIGS. 17A to 17C and 18), the deviation of the steered angles (FIG. 17C) is reset by the process of the step S214 of FIG. 13 (the deviation of the steered angles is made zero). During the determination period (the period from the time point t1 to the time point t5), the process of FIG. 13 is repeated. When the process goes to the step S213 through the steps S211 and S212 after the time point t1, the ECU 110 determines that the condition for “Flag (Determination Period) i−1=0?” is not satisfied. Accordingly, the process goes to a step S215, at which a maximum value of the steered angle is set (held) as the deviation of the steered angle. Then, the maximum value of the steered angle is continuously set (held) as the deviation of the steered angle at the step S215, until the time point t5 at which the determination period is terminated.

During the period from the time point t1 to the time point t5, which corresponds to the determination period, the maximum value of the steered angle is held as the deviation of the steered angle, as shown by the solid line in FIG. 17C. More exactly, even when the steered angle is saturated and starts to decrease at the time point t2, the deviation of the steered angle is not decreased, so that the maximum value of the steered angle is held as the deviation of the steered angle. Then, at the time point t3, at which the steered angle starts to increase again and goes over the saturated value, the deviation of the steered angle is also increased. At the time point t4, at which the steered angle is saturated again, the maximum value of the steered angle is likewise held as the deviation of the steered angle.

When the determination period is terminated at the time point t5, the process goes from the step S212 to the step S216. The process further moves on to the step S217, when the ECU 110 determines, at the step S216, that the condition of the step S216 is satisfied. The ECU 110 compares at the step S217 whether the deviation of the steered angle (that is, the maximum value of the output from the sensor 121 during the determination period), with a predetermined threshold value. Namely, the ECU 110 determines whether a condition for “the deviation of the steered angle<the predetermined threshold value” is satisfied. In the case that the condition for the step S217 is not satisfied, namely when the deviation of the steered angle is larger than the predetermined threshold value, the ECU 110 determines the normal condition of the steering angle sensor 121 at a step S219, because there is a normal reaction from the steering angle sensor 121 during the determination period, as shown by the solid line in FIG. 17B.

In the case that the above condition is satisfied at the step S217, namely in the case that the deviation of the steered angle is smaller than the predetermined threshold value, the ECU 110 determines the abnormal condition of the steering angle sensor 121, so that the process goes to a step S218 at which the warning lamp 132 is turned on. The ECU 110 determines the abnormal condition of the steering angle sensor 121, because the output from the sensor 121 does not go over the threshold value, even in spite that the vehicle has turned to the right or left, or the vehicle has passed through the curved road (as shown by the one-dot-chain line in FIGS. 17B and 17C).

According to the third embodiment, the process of FIG. 13 is repeatedly carried out at the predetermined cycle (at the predetermined crank angle), so that the determination period (the starting time point t1 and ending time point t5) can be automatically set. The ECU 110 determines whether there is the abnormal condition for the steering angle sensor 121, based on the comparison between the maximum value of the sensor output during the above determination period (t1 to t5) and the predetermined threshold value. As a result, the ECU 110 detects the abnormal condition of the steering angle sensor 121 at the earlier stage.

The above embodiment has the following advantages.

According to the above third embodiment, the diagnosis (determination) for the abnormal condition of the steering angle sensor 121 can be easily (simply) but accurately carried out, even in a vehicle in which the yaw-rate sensor or any other sensor similar to the yaw-rate sensor is not provided.

A detection accuracy depends on the vehicle speed in a system, in which the yaw-rate sensor is used (the sensitivity is low at the low vehicle speed). According to the above embodiment, however, the determination for the abnormal condition of the steering angle sensor 121 can be carried out with high precision, without depending on the vehicle speed.

According to the above embodiment, the ECU 110 comprises the program for detecting the maximum value of the sensor output during the determination period, the program for determining whether the above maximum value satisfies the certain amount through the comparison between the above maximum value and the predetermined threshold value, and the program for determining that the steering angle sensor 121 is in the abnormal condition when the ECU determines that the above maximum value does not satisfy the certain amount. Accordingly, the maximum value of the output from the steering angle sensor 121 can be held, whenever the vehicle has turned during the determination period. As a result, it is possible to easily determine after the determination period, whether the steering angle sensor has properly reacted or not, by comparing the maximum value of the output from the steering angle with the predetermined threshold value.

### Fourth Embodiment

A fourth embodiment will be explained with reference to the drawings. The abnormal condition determining system of the fourth embodiment is also applied to the vehicle control system. The system structure is the same to that of the third embodiment. An explanation for the system structure is omitted. Different points and features from the third embodiment will be mostly explained.

According to the fourth embodiment, the determination period is also automatically set, so that the ECU 110 determines whether the output from the steering angle sensor 121 during the determination period is in a normal range or not. And, as in the same manner to the third embodiment, the ECU 110 determines that the steering angle sensor 121 is in the abnormal condition, when the maximum value of the sensor output during the determination period does not exceed the predetermined threshold value.

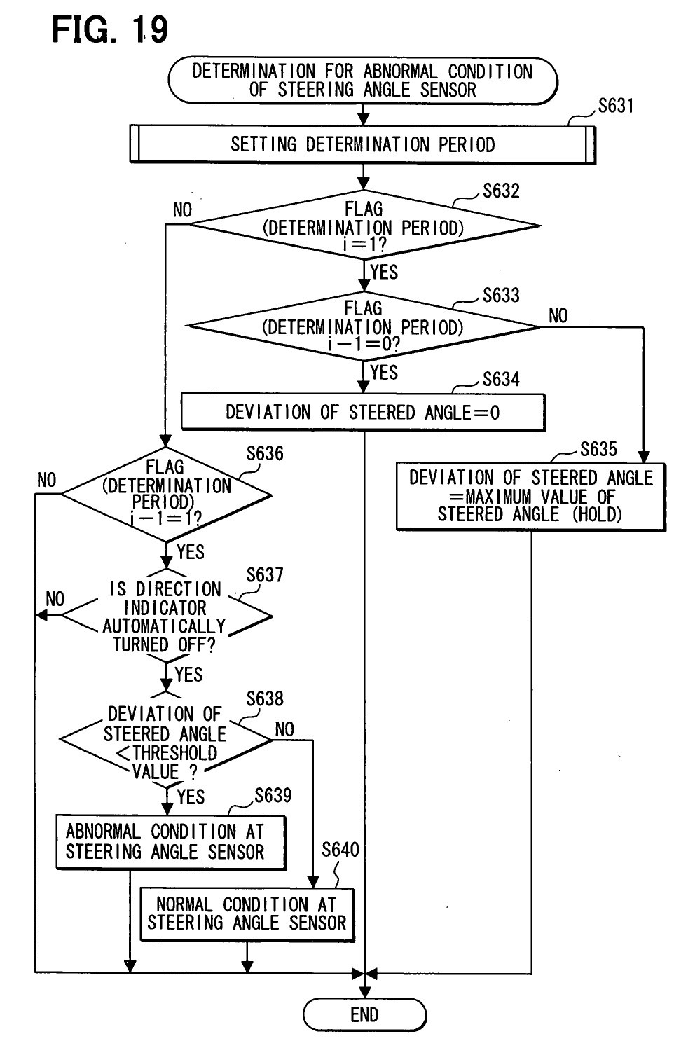

FIG. 19 is a flowchart showing a process for determining the abnormal condition of the steering angle sensor 121 according to the fourth embodiment. FIG. 20 is a flowchart showing a process for setting the determination period, which is one of the steps of FIG. 19. The determination of the abnormal condition is basically carried out by performing the program stored in the ROM 114. Each of parameters, which are used in the process of the program, is stored in the memory device (e.g. RAM 112, EEPROM 113) and renewed as needed.

At first, the process for setting the determination period is carried out at a step S631 of FIG. 19, namely in accordance with the program shown in FIG. 20.

At a step S741 of FIG. 20, a flag “Flag (Determination Period) i−1”, which shows data of the previous cycle whether the previous cycle is in the determination cycle, is renewed. More exactly, the process for “Flag (Determination Period) i−1=Flag (Determination Period) i” is carried out, as shown in FIG. 20. As in the same manner to the third embodiment, in a case that the step S741 is carried out for the first time, for example, after the battery has been changed, the value of the previous determination does not exist. Therefore, in such a case, an initial value “0” is set to “Flag (Determination Period) i−1”.

At a step S742, the ECU 110 determines whether the direction indicator switch 126 is turned on or not, namely whether the direction indicator switch 126 is operated by the vehicle driver. In the case the ECU 110 determines at the step S742 that the direction indicator switch 126 is operated by the vehicle driver (the direction indicator=ON), the ECU 110 sets at the next step S743 “1” to the flag “Flag (Determination Period) i”, under an assumption that the vehicle is going to turn in very near future. On the other hand, in the case the ECU 110 determines at the step S742 that the direction indicator switch 126 is not operated by the vehicle driver, the ECU 110 sets at the next step S742 “0” to the flag “Flag (Determination Period) i”, under an assumption that the vehicle is going to run straight. The process of FIG. 20 is terminated after any one of the steps S743 and S744 is carried out.

Back to the flow chart of FIG. 19, the ECU 110 determines at a step S632 whether the condition for “Flag (Determination Period) i=1?” is satisfied or not. In the case that the condition for “Flag (Determination Period) i=1?” is not satisfied, the ECU 110 determines that it is not in the determination period, and the process moves to a step S636. At the step S636, the ECU 110 determines whether the condition for “Flag (Determination Period) i−1=1?” is satisfied or not. In other words, the ECU 110 determines at the step S636 whether it is before or after the determination period. Then, if the condition for “Flag (Determination Period) i−1=1?” is not satisfied (that is, it is before the determination period), the process goes to an end.

On the other hand, when the condition for “Flag (Determination Period) i=1?” is satisfied at the step S632, the ECU 110 determines that it is in the determination period. Then, the process goes to a step S633, at which the ECU 110 determines whether a condition for “Flag (Determination Period) i−1=0?” is satisfied or not. In case of “YES” at the step S633, the ECU 110 determines that it is now the starting time point of the determination period. Then, the process goes to a step S634 to reset the deviation of the steered angle (the deviation of the steered angle=0). As a result, the determination period starts.

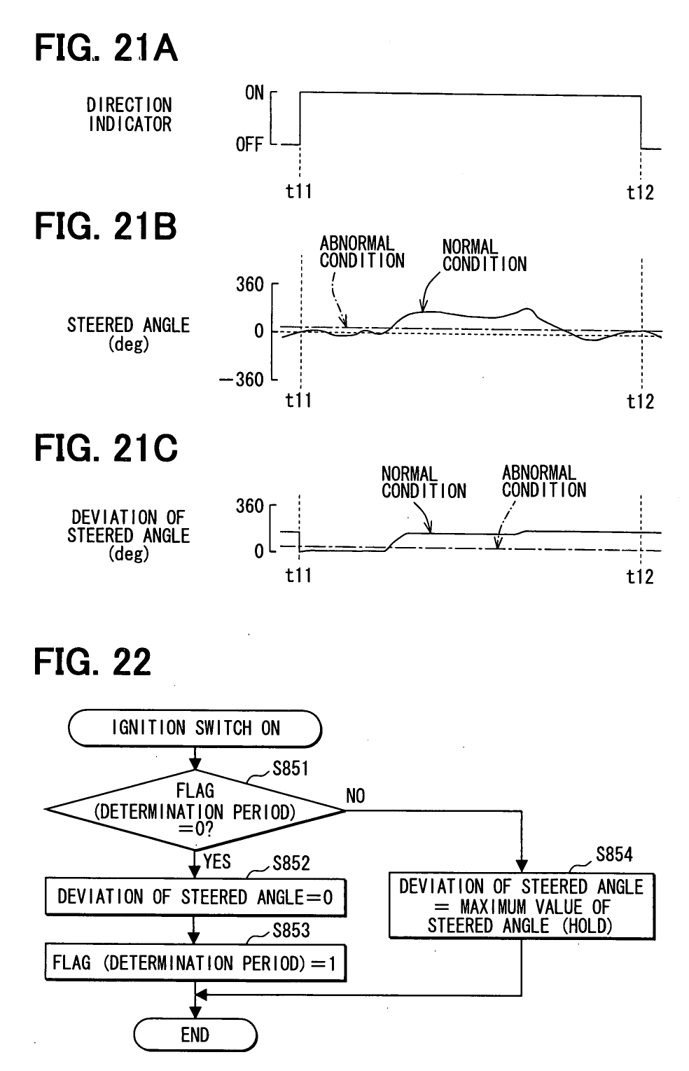

The process of FIG. 19 is repeatedly carried out even during the determination period. Therefore, the process goes to the step S633 again through the steps S631 and S632 at the next cycle, then the ECU 110 determines at the step S633 that the condition for “Flag (Determination Period) i−1=0?” is not satisfied. Accordingly, the process repeatedly goes to a step S635 thereafter, at which a maximum value of the steered angle is set (held) as the deviation of the steered angle. Thus, the maximum value of the steered angle is repeatedly set (held) as the deviation of the steered angle at the step S635, until the determination period is over. The process for holding the maximum value of the steered angle as the deviation of the steered angle is shown in FIGS. 21A to 21C (corresponding to the timing charts of FIGS. 17A to 17C), which are basically the same to that of the third embodiment. In FIGS. 21A to 21C, a time point t11 corresponds to the starting time point of the determination period, a time point t12 corresponds to the end of the determination period, and a period from t11 to t12 is the determination period.

When the determination period is over, the process goes from the step S632 to the step S636, at which the ECU 110 determines whether the condition “Flag (Determination Period) i−1=1?” is satisfied. In this situation, the determination at the step S636 is YES, so that the process goes to a step S637. The ECU 110 determines at the step S637 whether the direction indicator switch 126, which has been turned on at the starting time point t11 of the determination period, is automatically turned off as a result of an operation of the steering wheel at the end t12 of the determination period. In the case that the ECU 110 determines at the step S637 that the direction indicator switch 126 is not automatically turned off, the ECU 110 determines that the direction indicator switch 126 is turned off by the operation of the vehicle driver without turning the vehicle, so that the process goes to the end without carrying out the determination (diagnosis) for the abnormal condition of the steering angle sensor 121. On the other hand, in the case that the ECU 110 determines at the step S637 that the direction indicator switch 126 is automatically turned off (the vehicle has turned), the steps S638 and S639 or S640 are carried out to determine whether the steering angle sensor 121 is operating in the normal condition. The steps S638 and S639 or S640 of FIG. 19 are identical to those (S217 to S219) of the third embodiment shown in FIG. 13.

As explained above, according to the fourth embodiment, the process of FIG. 19 is repeatedly carried out at the predetermined cycle (for example, at the predetermined crank angle), so that the determination period is set. The ECU 110 determines whether there is the abnormal condition for the steering angle sensor 121, based on the comparison between the maximum value of the sensor output during the above determination period and the predetermined threshold value. As a result, the ECU 110 detects the abnormal condition of the steering angle sensor 121 at the earlier stage.

The fourth embodiment has the following advantages, which are the same to or additional features to those for the third embodiment.

According to the fourth embodiment, the determination (diagnosis) for the abnormal condition of the steering angle sensor 121 can be easily (simply) but accurately carried out, even in the vehicle in which the yaw-rate sensor or any other sensor similar to the yaw-rate sensor is not provided.

The determination period is set as such a short period, which starts from the time point (t11) shortly before the vehicle turning and ends at the time point (t12) shortly after the vehicle turning. The determination (diagnosis) for the abnormal condition can be more frequently carried out.

The end (t12) of the determination period is decided only when the ECU 110 determines that the direction indicator switch 126 is automatically turned off as the function of the steering wheel. Accordingly, the determination (diagnosis) for the abnormal condition is not carried out, if the direction indicator switch 126 is turned off by the operation of the vehicle driver. As a result, an erroneous determination (diagnosis) can be avoided.

### Fifth Embodiment

A fifth embodiment will be explained with reference to the drawings. The abnormal condition determining system of the fifth embodiment is also applied to the vehicle control system. The system structure is the same to that of the third embodiment. An explanation for the system structure is omitted. Different points and features from the third embodiment will be mostly explained.

According to the fifth embodiment, the determination period is also automatically set, so that the ECU 110 determines whether the output from the steering angle sensor 121 during the determination period is in a normal range or not. And, as in the same manner to the third embodiment, the ECU 110 determines that the steering angle sensor 121 is in the abnormal condition, when the maximum value of the sensor output during the determination period does not exceed the predetermined threshold value.

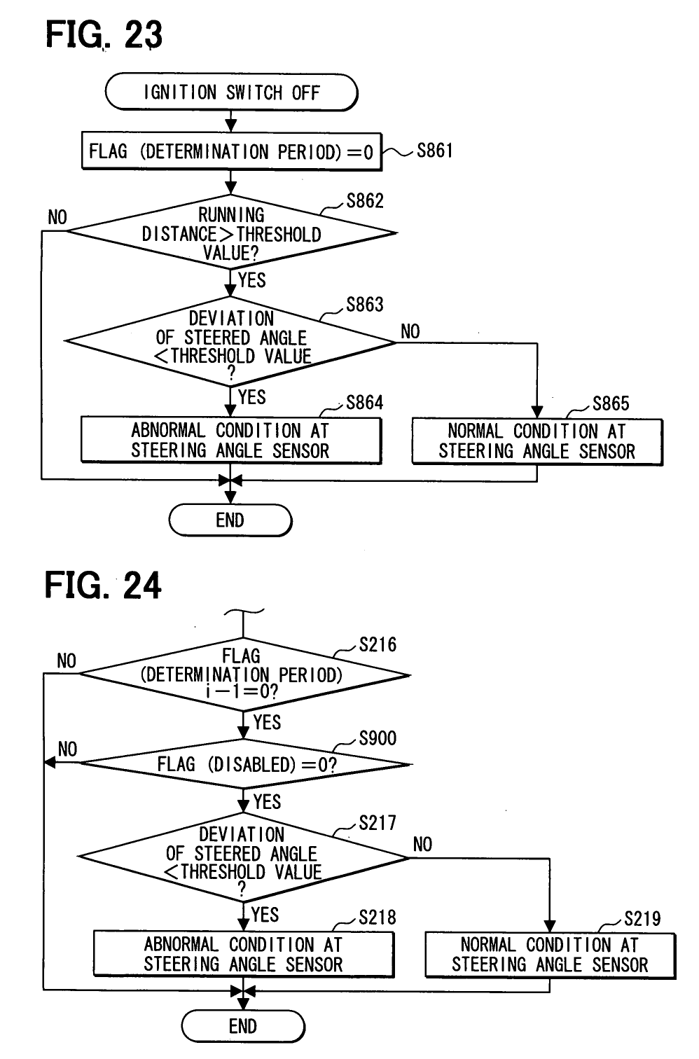

FIGS. 22 and 23 are flowcharts showing a process for determining the abnormal condition of the steering angle sensor 121 according to the fifth embodiment. The determination of the abnormal condition is basically carried out by performing the program stored in the ROM 114. Each of parameters, which are used in the process of the program, is stored in the memory device (e.g. RAM 112, EEPROM 113) and renewed as needed.

According to the fifth embodiment, when the ignition switch 125 is turned on by the vehicle driver, the process of FIG. 22 for setting the determination period starts upon a trigger signal from the ignition switch 125, and the process of FIG. 22 is repeatedly carried out at the predetermined cycle (or at the predetermined crank angle) until the ignition switch 125 is turned off.

At a step S851, the ECU 110 determines whether a condition for “Flag (Determination Period)=0?” is satisfied or not, that is, whether it is in the determination period or not. When the process of FIG. 22 is carried out for the first time, “0” is set as an initial value for the flag “Flag (Determination Period)”. Therefore, when the ignition switch 125 is turned on by the vehicle driver to start the engine operation, the ECU 110 determines at the step S851 that the condition for “Flag (Determination Period)=?” is satisfied. At a step S852 following the step S851, the deviation of the steered angle is reset (the deviation of the steered angle =0). At a step S853 following the step S852, the ECU 110 sets “1” for the flag “Flag (Determination Period)” as it is the starting time point for the determination period.

The process of FIG. 22 is repeatedly carried out at the predetermined cycle. At the next cycle, the ECU 110 determines at the step S852 that the condition for “Flag (Determination Period)=0?” is not satisfied. Accordingly, the maximum value from the steering angle sensor 121 is thereafter repeatedly set (renewed) at the step S854 as the deviation of the steered angle, until the ignition switch 125 is turned off by the vehicle driver. The holding process of the maximum value in FIG. 22 is basically the same to that (S213 to S215) of the third embodiment.

When the ignition switch 125 is turned off by the vehicle driver, its operation for turning-off is detected by any well-known sensing device. When it is detected, the process of FIG. 22 is terminated, whereas the process of FIG. 23 is carried out as an interrupting process.

At a step S861 of FIG. 23, the ECU 110 sets “0” to the flag “Flag (Determination Period)” showing that it is the end of the determination period. At a step S862 following the step S861, the ECU 110 obtains information for a vehicle running distance for one trip (one time travel) from a distance integrator (not shown), such as a trip meter, and compares the vehicle running distance with a predetermined threshold value. Namely, at the step S862, the ECU 110 determines whether a condition for “the vehicle running distance>the predetermined threshold value?” is satisfied or not. When the above condition is not satisfied (the vehicle running distance is smaller than the predetermined threshold value), the process goes to an end without performing the determination (diagnosis) for the steering angle sensor 121, so that the process of FIG. 23 is terminated. This is because it is not appropriate to carry out the determination (diagnosis) in such a situation.

On the other hand, when the above condition is satisfied (the vehicle running distance is larger than the predetermined threshold value) at the step S862, the following steps S863, S864 or S865 are carried out, to determine (diagnose) the abnormal condition for the steering angle sensor 121, as in the same manner to those (the steps S217, S218, S219) of the third embodiment (FIG. 13). Then, the process of FIG. 23 is terminated.

According to the fifth embodiment, the determination period is set by the operation of the ignition switch 125 by the vehicle driver. And the determination (diagnosis) for the abnormal condition of the steering angle sensor 121 is carried out by the comparison between the maximum value of the sensor output during the determination period and the predetermined threshold value. As a result, the abnormal condition of the steering angle sensor 121 can be detected at the earlier stage. The parameters (the steered angle, the deviation of the steered angle) for the fifth embodiment are basically identical to those for the fourth embodiment, as shown in FIG. 21.

The fifth embodiment has the following advantages, which are the same to or additional features to those for the first and/or fourth embodiments.

According to the above fifth embodiment, the determination (diagnosis) for the abnormal condition of the steering angle sensor 121 can be easily (simply) but accurately carried out, even in the vehicle in which the yaw-rate sensor or any other sensor similar to the yaw-rate sensor is not provided.

The end of the determination period is decided based on the vehicle running distance for one trip, which is longer than the predetermined value. Accordingly, compared with such a determination period which is decided by a predetermined time from a starting point of the engine operation, more accurate determination can be possible. In other words, any erroneous determination, which could otherwise occur when an engine warm-up operation is carried out, can be avoided.

### Modifications for Third to Fifth Embodiments

In the above third embodiment, the same threshold value is used for determining the starting time point and the ending time point for the determination period based on the difference of the wheel speed. However, different values may be used for the above threshold value. The key points for the program for automatically setting the determination period are to decide the starting time point of the determination period when the difference of the right and left wheel speeds becomes larger than the value at the straight forwarding of the vehicle (i.e. the maximum value for the difference of the wheel speed at the vehicle running on the straight road), and to decide the ending time point of the determination period when the difference of the right and left wheel speeds comes close to (becomes lower than) the value at the straight forwarding of the vehicles.

In the above embodiments, the difference of the wheel speed is directly calculated when determining whether the difference of the wheel speed is larger than the predetermined threshold value. However, a difference of the running distance (the wheel speed X time) between the right and left vehicle wheels, or an integrated amount of the difference of the wheel speed may be calculated and compared with the respective threshold values. Furthermore, the curvature of radius of the road (a curving degree of the road) may be calculated from the difference of the wheel speeds based on the relation shown in FIG. 15, and the determination period (the starting and ending time points thereof) may be set according to the values for curvature of radius of the road.

In the above fourth embodiment, the starting time point of the determination period may be set when the direction indicator switch 126 is turned on and the maximum value of the steered angle is held as the deviation of the steered angle. When the direction indicator switch 126 is turned off, the ending time point of the determination period may be set and the process for determination for the abnormal condition of the steering angle sensor may be carried out, as in the same manner to the fifth embodiment.

In the above fifth embodiment, the ending time point of the determination period is automatically set based on the operation, in which the ignition switch 125 is turned off for one time, after the starting time point of the determination period has been set. However, the ending time point of the determination period may be set based on such an operation, in which the ignition switch 125 is turned off for predetermined multiple times. The advantages of the fifth embodiment can be likewise obtained.

For example, the step S862 of FIG. 23 may be replaced by the following step. According to the alternative step, the number of operation for turning off the ignition switch 125 is counted, and when the turn-off operation is carried out more than three times, the process goes to the step S863, so that the determination (diagnosis) for the abnormal condition of the steering angle sensor 121 is carried out. The starting time point of the determination period as well as the number of the operation for turning off the ignition switch 125 after the start of the determination period may be memorized in the non-volatile memory device, such as EEPROM 113, so that the data can be held in the memory device of the ECU 110, even after the ignition switch is turned off.

In the case that the ECU 110 is so structured that the power supply to the ECU 110 is cut off in association with the turn-off operation of the ignition switch 125, a timer may be provided in the ECU 110 so that the power is continuously supplied to the ECU 110 for a certain period of time even after the turn-off of the ignition switch 125. According to such an arrangement, a sufficient time is obtained so that the process of the ECU for the determination (diagnosis) for the abnormal condition of the steering angle sensor can be surely done.

In the above embodiments, the determination period is automatically set depending on predetermined vehicle operational conditions (such as, the operation of the direction indicator switch 126, or the ignition switch 125) or vehicle driving conditions (such as, the difference of the right and left wheel speeds). A means for changing the setting conditions for the determination period may be provided, so that the setting condition may be changed by the vehicle driver. For example, a program may be provided in the ECU 110, so that the setting conditions for the determination period is displayed on the display device and the setting conditions are changed by the vehicle driver through the operation on the display. According to such a modified system, the setting conditions for the determination period can be changed depending on the driver's habit or other circumstances and the determination period can be optimized by the vehicle driver.

Furthermore, such a means or a program may be added, according to which the setting conditions for the determination period may be temporally disabled based on the operation by the user or when a certain condition is satisfied. For example, as shown in FIG. 24, a step S900 may be added before the step S217 of the third embodiment (FIG. 13). The ECU 110 determines at the step S900 whether a condition for “Flag (Disabled)=0?” is satisfied or not, wherein the flag “Flag (Disabled)=0” indicates that the setting conditions for the determination period is not disabled. The process goes to the next step S217, only when the condition for “Flag (Disabled)=0?” is satisfied at the step S900. Then, the ECU 110 carries out the determination (diagnosis) for the abnormal condition of the steering angle sensor 121 at the step S217, as in the same manner to the third embodiment. The value of “1 (the setting conditions are disabled)” or “0 (the setting conditions are effective)” is set for the flag “Flag (Disabled)” by the operation of the vehicle driver or when a certain condition is met. For example, in the case that the vehicle driver desires that the determination (diagnosis) for the abnormal condition is carried out only when the vehicle is running at a low speed, the value “0” may be set to the flag “Flag (Disabled)” when a program for monitoring the vehicle running condition detects the low-speed running. According to such an arrangement, the determination period can be much more flexibly set as a most appropriate period in accordance with various circumstances.

In the above embodiments, the maximum value of the sensor output (the deviation of the steered angle) during the determination period is compared with the predetermined threshold value, for the purpose of determining the abnormal condition of the steering angle sensor 121. Instead of the maximum value, however, an integrated value of the sensor output during the above determination period may be used for the comparison.

Furthermore, the determination for abnormal condition may be carried out without using the above maximum value or the integrated value. For example, a transition of the sensor output is recorded as a graph, and the determination for abnormal condition may be carried out by detecting whether there is a certain amount of change in the sensor outputs based on analysis of the graph.

According to the invention, the determination for the abnormal condition of the steering angle sensor can be simply and accurately carried out, when there is provided with the following two programs; the program for automatically setting the determination period (the starting and ending time points) depending on the vehicle operation satisfying the predetermined condition or the vehicle running situation satisfying the predetermined condition, and the program for determining the abnormal condition of the steering angle sensor when the output change during the determination period does not have the certain amount. Accordingly, the vehicle operation satisfying the predetermined condition is not limited to the operation of the direction indicator switch 126 or the operation of the ignition switch 125, and the vehicle running situation satisfying the predetermined condition is likewise not limited to the difference of the right and left wheel speeds. Any other vehicle operations or vehicle running conditions may be applied to the present invention.

The determination (diagnosis) for the abnormal condition of the steering angle sensor 121 can be realized without setting the determination period, if the difference of the right and left wheel speeds is used for the diagnosis. More exactly, the abnormal condition determining system may comprise: a program for calculating the difference of the right and left wheel speeds from the vehicle wheel sensors 123; and a program for determining the abnormal condition of the steering angle sensor 121, when the output change of the steering angle sensor 121 does not reach a predetermined amount (a threshold value) even in the case that the difference of the right and left wheel speeds is larger than a predetermined level. According to such an arrangement, the above determination can be always carried out, when the difference of the right and left wheel speeds and the output change of the steering angle sensor 121 are monitored under a preset condition. Therefore, the occurrence of the abnormal condition of the steering angle sensor 121 can be timely detected.

The threshold value (e.g. the threshold value used in the step S217 of FIG. 13) for the determination of the abnormal condition may not be limited to a fixed amount. For example, a program may be added to the above third embodiment, wherein a curvature radius of a road (on which the vehicle is running) is calculated from the difference of the right and left wheel speeds, and the threshold value may be changed depending on the curvature radius of the road. The threshold value may be changed by the user.

According to the invention, the determination of the abnormal condition can be carried out for any kinds of structures for the steering angle sensor 121.

In the above embodiments, the steering angle sensor is used for the purpose of correcting the engine load. The present invention can be applied to any kinds of the applications for the steering angle sensors. For example, the invention can be applied to the steering angle sensor, which is applied to the steering control.

In the above embodiments, the system for determining the abnormal condition of the steering angle sensor is mounted in the engine control ECU 110. However, the system may be mounted in other control ECUs for the vehicle, for example in the steering control ECU.

In the above embodiments, the programs (software) are provided to perform the function of determining the abnormal condition of the steering angle sensor. However, hardware may be provided to perform the same function.

In the above embodiments, the warning lamp 132 is turned on, when the ECU 110 determines the abnormal condition (at the step S218 of FIG. 13). Instead of displaying the abnormal condition by the warning lamp, it is also possible to memorize a diagnosis code corresponding to such abnormal condition in the memory device, for example, in the EEPROM 113.

What is claimed is:

1. An abnormal condition determining system for a steering angle sensor of a vehicle comprising:
a first means for detecting whether the vehicle has passed through a curved road, based on geographical data and position data from a navigation system; and
a second means for determining an abnormal condition of the steering angle sensor, when an output change of the steering angle sensor does not reach a predetermined amount in spite that the first means detects that the vehicle has passed through the curved road.

2. An abnormal condition determining system according to the claim 1, wherein
the curved road is selected in advance.

3. An abnormal condition determining system according to the claim 2, wherein
the curved road is selected by a user on a map of the navigation system.

4. An abnormal condition determining system according to the claim 2, wherein
an optional area is chosen by a user a map of the navigation system, and the curved road included in the area is selected.

5. An abnormal condition determining system according to the claim 2, wherein
the curved road is automatically selected depending on a predetermined condition.

6. An abnormal condition determining system according to the claim 1, wherein
the first means detects a vehicle running period on the curved road, based on the geographical data and the position data from the navigation system, and
the second means comprises;
a third means for detecting a maximum value or an integrated value of an output from the steering angle sensor during the vehicle running period on the curved road;
a fourth means for determining whether the maximum value or the integrated value of the output from the steering angle sensor, which is detected by the third means, reaches a predetermined threshold value through the comparison between the maximum value or the integrated value and the predetermined threshold value; and
a fifth means for determining that the steering angle sensor is in an abnormal condition, when the fourth means determined that the maximum value or the integrated value does not reach the predetermined threshold value.

7. An abnormal condition determining system according to the claim 6, further comprising:
a sixth means for determining whether the vehicle has passed through an intersection by running on a straight road or on a curved road, when the intersection has the straight road and the curved road, wherein
the determination of the fourth means is carried out when the sixth means determined that the vehicle runs on the straight road, and
the determination of the fourth means is not carried out when the sixth means determined that the vehicle runs on the curved road.

8. An abnormal condition determining system according to the claim 6, wherein
the first means always determines whether the road, on which the vehicle is running, is the curved road to detect the vehicle running period on the curved road.

9. An abnormal condition determining system according to the claim 6, wherein
the first means detects a starting time point of the vehicle running period on the curved road, based on a detection that the first means detects a curved road ahead in a direction of vehicle running.

10. An abnormal condition determining system according to the claim 6, wherein
the predetermined threshold value, with which the maximum value or the integrated value of the output from the steering angle sensor is compared by the fourth means, is changed depending on a curvature radius of the curved road, which is included in the vehicle running period on the curved road.

11. An abnormal condition determining system for a steering angle sensor of a vehicle comprising:
a first means for detecting that a vehicle running track has plotted a curved line, based on position data from a navigation system; and
a second means for determining an abnormal condition of the steering angle sensor, when an output change of the steering angle sensor does not reach a predetermined amount in spite that the first means detects that the vehicle running track has plotted the curved line.

12. An abnormal condition determining system for a steering angle sensor of a vehicle comprising:
a first means for automatically setting a determination period during which it is determined whether an output of the steering angle sensor is in a normal condition or not, wherein a starting time point and an ending time point of the determination period are automatically set when at least one of conditions for an vehicle operation and a vehicle running condition satisfies a predetermined condition; and
a second means for determining an abnormal condition of the steering angle sensor, when an output change of the steering angle sensor during the above determination period does not reach a predetermined amount.

13. An abnormal condition determining system according to the claim 12, wherein
the conditions for the vehicle operation includes an operation of an ignition switch; and
the first means comprises;
a third means for automatically setting the starting time point of the determination period based on a turn-on operation of the ignition switch; and
a fourth means for automatically setting the ending time point of the determination period, when the ignition switch is turned off by a predetermined number since the starting time point has been set.

14. An abnormal condition determining system according to the claim 13, wherein
the predetermined number, by which the ending time point is decided, is one, and
the fourth means sets the ending time point, when a vehicle running distance for a period of one trip is larger than a predetermined distance.

15. An abnormal condition determining system according to the claim 12, wherein
the conditions for the vehicle operation includes an operation of a direction indicator switch, which is operated by a vehicle driver; and
the first means comprises;
a fifth means for automatically setting the starting time point of the determination period based on a turn-on operation of the direction indicator switch; and
a sixth means for automatically setting the ending time point of the determination period based on a turn-off operation of the direction indicator switch, since the starting time point has been set.

16. An abnormal condition determining system according to the claim 15, wherein
the direction indicator switch is automatically turned off when a steering wheel returns from a curved position to a straight running position, and
the sixth means automatically sets the ending time point of the determination period, when the direction indicator switch is automatically turned off as a result of the operation of the steering wheel.

17. An abnormal condition determining system according to the claim 12, wherein
the vehicle has an anti-lock braking system, according to which a vehicle wheel lock is prevented during a braking operation by controlling braking pressure based on an information for rotational speed of respective vehicle wheels,
the vehicle running condition is a difference of wheel speeds between right and left vehicle wheels, which is obtained from the information for the rotational speed of the respective vehicle wheels, and
the first means comprises;
a seventh means for automatically setting the starting time point of the determination period, when the difference of wheel speeds between right and left vehicle wheels becomes larger than that in the vehicle running on the straight road, and
an eighth means for automatically setting the ending time point of the determination period, when the difference of wheel speeds between right and left vehicle wheels becomes to such a value, which corresponds to a difference of wheel speeds between right and left vehicle wheels in the vehicle running on the straight road.

18. An abnormal condition determining system according to the claim 12, wherein
the predetermined condition for setting the determination period is changed by the user after the determination period is automatically set under the predetermined condition.

19. An abnormal condition determining system according to the claim 12, further comprising:
a means for temporally disabling the predetermined condition for setting the determination period, when manually operated by a user or when a certain condition is satisfied.

20. An abnormal condition determining system according to the claim 12, wherein
the second means for determining the abnormal condition of the steering angle sensor comprises;
a tenth means for detecting for detecting a maximum value or an integrated value of an output from the steering angle sensor during the determination period, which is set by the first means;
an eleventh means for determining whether the maximum value or the integrated value of the output from the steering angle sensor, which is detected by the tenth means, reaches a predetermined threshold value through the comparison between the maximum value or the integrated value and the predetermined threshold value; and
a twelfth means for determining that the steering angle sensor is in an abnormal condition, when the eleventh means determined that the maximum value or the integrated value does not reach the predetermined threshold value.

21. An abnormal condition determining system for a vehicle which has an anti-lock braking system, according to which a vehicle wheel lock is prevented during a braking operation by controlling braking pressure based on information for rotational speed of respective vehicle wheels, comprising:
a first means for calculating a difference of wheel speeds between right and left vehicle wheels, based on the information for rotational speed of respective vehicle wheels; and
a second means for determining an abnormal condition of the steering angle sensor, when an output change of the steering angle sensor does not reach a predetermined amount in spite that the difference of wheel speeds between right and left vehicle wheels calculated by the first means is larger than that of the vehicle running on a straight road.
